(19) United States
(12) Patent Application Publication
(10) Pub. No.: US 2023/0077527 A1
(43) Pub. Date: Mar. 16, 2023

(54) LOCAL AGENT SYSTEM FOR OBTAINING HARDWARE MONITORING AND RISK INFORMATION UTILIZING MACHINE LEARNING MODELS

(71) Applicant: AJAY SARKAR, ENCINITAS, CA (US)

(72) Inventor: AJAY SARKAR, ENCINITAS, CA (US)

(21) Appl. No.: 17/838,187

(22) Filed: Jun. 11, 2022

Related U.S. Application Data
(63) Continuation-in-part of application No. 17/139,939, filed on Dec. 31, 2020.
Application No. 17/139,939 is a continuation-in-part of application No. 17/399,549, filed on Aug. 11, 2021.

(51) Int. Cl. G06Q 10/06

(52) U.S. Cl. CPC G06Q 10/0635; G06Q 10/067

(57) ABSTRACT

In one aspect, a hardware risk information system for implementing a local risk information agent system for assessing a risk score from a hardware risk information comprising a local risk information agent that is installed in and running on a hardware system of an enterprise asset, wherein the local risk information agent manages a collection of the hardware risk information used to calculate a risk score of the hardware system of the enterprise asset by tracking a specified set of parameters about the hardware system, wherein the local risk information agent pushes the collection of the hardware risk information to a risk management hardware device, and wherein on a periodic basis, the local risk information agent uses a risk management hardware device to write the collection of the hardware risk information in a secure manner using a cryptographic key; a risk management hardware device comprising a repository for all the risk parameters of the hardware system of the enterprise asset, wherein the risk management hardware device generates the risk score for the hardware system using the collection of the hardware risk information, and wherein the risk management hardware device comprises a neural network processing unit (NNPU) used for local machine-learning processing and summarization operations used to generate the risk score, wherein the risk management hardware device authenticates the collection of the hardware risk information using the cryptographic hardware and then writes the collection of the hardware risk information onto an internal memory, and wherein the NNPU is configured to receive the collection of the hardware risk information for creating a risk score based on a current chunk of data and the older risk scores, and uses one or more machine learning (ML) models to calculate the risk score at an enterprise asset's system level of the enterprise asset; and an analytics and dashboarding component that receives the risk score and provides the risk score as the risk score information via a set of graphical components viewable by a user, and wherein the set of graphical components displays a set of insights about the plurality of enterprise assets based on the risk score data obtained by the plurality of local risk information agents.

### CLAIM OF PRIORITY

This application claims priority to and is a continuation-in-part of U.S. patent application Ser. No. 17/139,939 filed on Dec. 31, 2020, and titled METHODS AND SYSTEMS OF RISK IDENTIFICATION, QUANTIFICATION, BENCHMARKING AND MITIGATION ENGINE DELIVERY. This application is hereby incorporated by reference in its entirety.

### FIELD OF INVENTION

This invention relates to computer and network security and more specifically to a local agent system for obtaining hardware monitoring and risk information.

### BACKGROUND

Executives and companies across different industries are faced with the daunting task of identifying, understanding, and managing ever-evolving risk and compliance threats and challenges in their organizations. risk identification and management activities are often conducted by way of manual assessments and audits. Such manual assessments and audits only provide a brief snapshot of risk at a moment in time and do not keep pace with ongoing enterprise threats and challenges. Current risk management programs are often decentralized, static and reactive and their design has focused on governance and process rather than real-time risk identification and quantification of risk exposure. This can hamper Boards' abilities to make forward-looking risk mitigation decisions and investments.

In between such manual assessments and audits, it is difficult to make an accurate assessment of risk given the volume and disparate nature of the data that is needed and available at any point in time to conduct such a review. Data sources can be limited, incomplete and opaque.

In addition, organizational change that occurs in between manual assessments and audits can impact risk profile. Examples of change include new projects and programs, employee changes, new systems, vendors, users, administrators and new compliance laws, regulations, and standards.

The risks to an enterprise can include various factors, including, inter alia: security and data privacy breaches (e.g. which threaten C-level jobs, potentially cost organizations millions of dollars, and can have personal legal implications for board members); data maintenance and storage issues; broken connectivity between security strategy and business initiatives; fragmented solutions covering security, privacy and compliance; regulatory enforcement activity; moving applications to a cloud-computing platform; and an inability to quantify the associated risk. Accordingly, a solution is needed that is a real-time, on-demand quantification tool that provides an enterprise-wide, centralized view of an organization's current risk profile and risk exposure.

### SUMMARY OF THE INVENTION

In one aspect, a hardware risk information system for implementing a local risk information agent system for assessing a risk score from a hardware risk information comprising a local risk information agent that is installed in and running on a hardware system of an enterprise asset, wherein the local risk information agent manages a collection of the hardware risk information used to calculate a risk score of the hardware system of the enterprise asset by tracking a specified set of parameters about the hardware system, wherein the local risk information agent pushes the collection of the hardware risk information to a risk management hardware device, and wherein on a periodic basis, the local risk information agent uses a risk management hardware device to write the collection of the hardware risk information in a secure manner using a cryptographic key; a risk management hardware device comprising a repository for all the risk parameters of the hardware system of the enterprise asset, wherein the risk management hardware device generates the risk score for the hardware system using the collection of the hardware risk information, and wherein the risk management hardware device comprises a neural network processing unit (NNPU) used for local machine-learning processing and summarization operations used to generate the risk score, wherein the risk management hardware device authenticates the collection of the hardware risk information using the cryptographic hardware and then writes the collection of the hardware risk information onto an internal memory, and wherein the NNPU is configured to receive the collection of the hardware risk information for creating a risk score based on a current chunk of data and the older risk scores, and uses one or more machine learning (ML) models to calculate the risk score at an enterprise asset's system level of the enterprise asset; and an analytics and dashboarding component that receives the risk score and provides the risk score as the risk score information via a set of graphical components viewable by a user, and wherein the set of graphical components displays a set of insights about the plurality of enterprise assets based on the risk score data obtained by the plurality of local risk information agents.

### BRIEF DESCRIPTION OF THE DRAWINGS

FIG. 1 illustrates an example process for implementing risk identification, quantification, and mitigation engine delivery, according to some embodiments.

FIG. 2 illustrates an example risk identification, quantification, and mitigation engine delivery platform, according to some embodiments.

FIG. 3 illustrates an example process for implementing risk identification, quantification, and mitigation engine delivery platform, according to some embodiments.

FIG. 4 illustrates an example risk assessment process, according to some embodiments.

FIG. 5 illustrates an example automatic risk scoring process 500, according to some embodiments.

FIG. 6 illustrates an example automatic risk scoring process, according to some embodiments.

FIG. 7 illustrates an example data collection, reporting and communication process, according to some embodiments.

FIG. 8 illustrates an example process for generating a report using NLG, according to some embodiments.

FIG. 9 illustrates a risk identification, quantification, and mitigation engine delivery platform with modularized-core capabilities and components, according to some embodiments.

FIG. 10 illustrates an example process for enterprise risk analysis, according to some embodiments.

FIG. 11 illustrates an example process for implementing a risk architecture, according to some embodiments.

FIG. 12 illustrates an example hardware risk information system for implementing an agent system for hardware risk information, according to some embodiments.

FIG. 13 illustrates an example risk management hardware device according to some embodiments.

FIG. 14 illustrates an example process for using a risk management hardware device for calculating the risk score of an enterprise asset, according to some embodiments.

FIG. 15 illustrates a system of risk management software architecture according to some embodiments.

FIG. 16 illustrates an example process implementing automated risk scoring, according to some embodiments.

FIG. 17 illustrates an example process for determining a valuation of risk exposure, according to some embodiments.

FIG. 18 illustrates an example process for determining a risk remediation cost, according to some embodiments.

FIG. 19 illustrates an example process for anomaly detection in risk scores, according to some embodiments.

FIG. 20 illustrates an example process for industry benchmarking, according to some embodiments.

FIG. 21 illustrates an example process for risk scenario testing, according to some embodiments.

FIG. 22 illustrates an example process implemented using automatic questionnaires and NLG, according to some embodiments.

FIG. 23 illustrates an example process implemented using reporting using NLG, according to some embodiments.

FIG. 24 illustrates an example process of automatic role assignment for role-based access control, according to some embodiments.

FIG. 25 illustrates an example process implemented using intelligence for adding risk scoring, according to some embodiments.

FIG. 26 illustrates an example system for aggregating risk parameters, according to some embodiments.

FIG. 27 illustrates an example process for sixth-sense decision-making, according to some embodiments.

FIGS. 28-30 illustrate an example set of AI/ML benchmarking processes, according to some embodiments.

FIG. 31 illustrates an example risk geomap, according to some embodiments.

FIG. 32 illustrates an example risk analytics dashboard, according to some embodiments.

FIG. 33 illustrates an example risk benchmark chart according to some embodiments.

FIGS. 34-36 illustrate an example set of charts showing risk exposure distribution by threats, locations, sources, and topology, according to some embodiments.

FIG. 37 illustrates an example system for AI/ML modeling, according to some embodiments.

FIG. 38 illustrates an example hierarchy of models, according to some embodiments.

FIG. 39 illustrates an example process flow utilizing synthetic data, according to some embodiments.

FIG. 40 illustrates an example AI/ML pipeline, according to some embodiments.

FIG. 41 illustrates an example prediction pipeline, according to some embodiments.

FIG. 42 illustrates an example quantification pipeline, according to some embodiments.

FIG. 43 illustrates a FastAPI object creation and mounting process, according to some embodiments.

FIG. 44 illustrates an example process for deploying an API configuration file to a socket, according to some embodiments.

FIG. 45 illustrates an example screen shot of a chart illustrating example risk values, according to some embodiments.

FIGS. 46-49 illustrates an example tables of synthetic data that can be utilized by the systems and processes provided herein, according to some embodiments.

FIG. 50 illustrates an example process for triggering manual approval, according to some embodiments.

FIG. 51 illustrates an example process for triggering assessment and data usage, according to some embodiments.

FIG. 52 depicts an example computing system that can be configured to perform any one of the processes provided herein.

The Figures described above are a representative set and are not exhaustive with respect to embodying the invention.

### DESCRIPTION

Disclosed are a system, method, and article of a local agent system for obtaining hardware monitoring and risk information utilizing machine learning models. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to ‘one embodiment,’ ‘an embodiment,’ ‘one example,’ or similar language means that a particular feature, structure, or characteristic described in connection with the embodiment is included in at least one embodiment of the present invention. Thus, appearances of the phrases ‘in one embodiment,’ ‘in an embodiment,’ and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Example definitions for some embodiments are now provided.

Application programming interface (API) is a set of subroutine definitions, communication protocols, and/or tools for building software. An API can be a set of clearly defined methods of communication among various components.

Application-specific integrated circuit (ASIC) is an integrated circuit (IC) chip customized for a particular use.

Artificial Intelligence (AI) is the simulation of intelligent behavior in computers, or the ability of machines to mimic intelligent human behavior.

Business Initiative(s) can include a specific set of business priorities and strategic goals that have been determined by the organization. Business Initiatives can include ways the organization/enterprise indicates what its vision is, how it will improve, and what it believes it needs to do in order to be successful.

Business Intelligence (BI) is the analysis of business information in a way to provide historical, current, and future predictive views of business performance. BI is descriptive analytics.

Cloud computing can involve deploying groups of remote servers and/or software networks that allow centralized data storage and online access to computer services or resources. These groups of remote servers and/or software networks can be a collection of remote computing services.

Corporate Intelligence (CI) includes the analysis of Business Intelligence data by AI in order to optimize business performance.

Common Vulnerabilities and Exposures (CVE) can be a collection of publicly known software vulnerabilities. The CVE system provides a reference-method for publicly known information-security vulnerabilities and exposures.

CXO is an abbreviation for a top-level officer within a company, where the “X” could stand for, inter alia, “Executive,” “Operations,” “Marketing,” “Privacy,” “Security” or “Risk”.

Data Model (DM) can be a model that organizes data elements and determines the structure of data.

Enterprise risk management (ERM) in business includes the methods and processes used by organizations to identify, assess, manage, and mitigate risks and identify opportunities to support the achievement of business objectives.

Exponentiation is a mathematical operation, written as bⁿ, involving two numbers, the base b and the exponent or power n, and pronounced as “b raised to the power of n”. When n is a positive integer, exponentiation corresponds to repeated multiplication of the base: that is, bⁿ is the product of multiplying n bases.

Google Cloud Platform (GCP) is a suite of cloud computing services that runs on the same infrastructure that Google uses internally for its end-user products.

Gunicorn is a Python Web Server Gateway Interface (WSGI) HTTP server. It is a pre-fork worker model, ported from Ruby's Unicorn project. The Gunicorn server is broadly compatible with a number of web frameworks, simply implemented, light on server resources and fairly fast.[3] It is often paired with NGINX, as the two have complementary features. Herein, it is provided by way of example and it is noted that other WSGIs can be utilized in lieu of Gunicorn in various example embodiments.

Internet of things (IoT) describes the network of physical objects that are embedded with sensors, software, and other technologies for the purpose of connecting and exchanging data with other devices and systems over the Internet.

Machine Learning can be the application of AI in a way that allows the system to learn for itself through repeated iterations. It can involve the use of algorithms to parse data and learn from it. Machine learning is a type of artificial intelligence (AI) that provides computers with the ability to learn without being explicitly programmed. Machine learning focuses on the development of computer programs that can teach themselves to grow and change when exposed to new data. Example machine learning techniques that can be used herein include, inter alia: decision tree learning, association rule learning, artificial neural networks, inductive logic programming, support vector machines, clustering, Bayesian networks, reinforcement learning, representation learning, similarity, and metric learning, and/or sparse dictionary learning.

Natural-language generation (NLG) can be a software process that transforms structured data into natural language. NLG can be used to produce long form content for organizations to automate custom reports. NLG can produce custom content for a web or mobile application. NLG can be used to generate short blurbs of text in interactive conversations (e.g. with a chatbot-type system, etc.) which can be read out by a text-to-speech system.

Network interface controller (NIC) is a computer hardware component that connects a computer to a computer network.

Neural network is an artificial neural network composed of artificial neurons or nodes.

Neural Network Processing Unit (NNPU) is a specialized hardware accelerator and/or computer system designed to accelerate specified artificial neural networks.

Predictive Analytics includes the finding of patterns from data using mathematical models that predict future outcomes. Predictive Analytics encompasses a variety of statistical techniques from data mining, predictive modeling, and machine learning, that analyze current and historical facts to make predictions about future or otherwise unknown events. In business, predictive models exploit patterns found in historical and transactional data to identify risks and opportunities. Models can capture relationships among many factors to allow assessment of risk or potential risk associated with a particular set of conditions, guiding decision-making for candidate transactions.

Representational state transfer (REST) is a software architectural style that was created to guide the design and development of the architecture for the World Wide Web. REST defines a set of constraints for how the architecture of an Internet-scale distributed hypermedia system, such as the Web, should behave. The REST architectural style emphasizes the scalability of interactions between components, uniform interfaces, independent deployment of components, and the creation of a layered architecture to facilitate caching components to reduce user-perceived latency, enforce security, and encapsulate legacy systems.

Risk Program, and Portfolio Management (RPPM). Risk management is the practice of initiating, planning, executing, controlling, and closing the work of a team to achieve specific risk goals and meet specific success criteria at the specified time. Program management is the process of managing several related risks, often with the intention of improving an organization's overall risk performance. Portfolio management is the selection, prioritization and control of an organization's risks and programs in line with its strategic objectives and capacity to deliver.

Recurrent neural network (RNN) is a class of artificial neural networks where connections between nodes form a directed graph along a temporal sequence. In one example, derived from feedforward neural networks, RNNs can use their internal state (memory) to process variable length sequences of inputs.

Spider chart is a graphical method of displaying multivariate data in the form of a two-dimensional chart of three or more quantitative variables represented on axes starting from the same point. Various heuristics, such as algorithms that plot data as the maximal total area, can be applied to sort the variables (e.g. axes) into relative positions that reveal distinct correlations, trade-offs, and a multitude of other comparative measures.

Synthetic data can be any production data applicable to a given situation that are not obtained by direct measurement. This can include data generated by a computer simulation(s).

Example Methods

Disclosed are various embodiments of a risk identification, quantification, and mitigation engine. The risk identification, quantification, and mitigation engine provides various ERM functionalities. The risk identification, quantification, and mitigation engine can leverage various advanced algorithmic technologies that include AI, Machine Learning, and block chain systems. The risk identification, quantification, and mitigation engine can provide proactive and continuous risk monitoring and management of all key risks collectively across an organization/entity. The risk identification, quantification, and mitigation engine can be used to manage continuous risk exposure, as well as assisting with the reduction of residual risk.

Accordingly, examples of a risk identification, quantification, and mitigation engine are provided. A risk identification, quantification, and mitigation engine can obtain data and analyze multiple complex risk problems. The risk identification, quantification, and mitigation engine can analyze, inter alia: global organization(s) data (e.g. multiple jurisdictions data, local business environment data, geo political data, culturally diverse data, etc.); multiple stakeholders data (e.g. business line data, functions data, levels of experience data, third party data, contractor data, etc.); multiple risk category data (e.g. operational data, regulatory data, compliance data, privacy data, cybersecurity data, financial data, etc.); complex IT structure data (e.g. system data, application data, classification data, firewall data, vendor data, license data, etc.); etc. The risk identification, quantification, and mitigation engine can utilize data that is aggregated and analyzed to create real-time, collective, and predictive custom reports for different CXOs. The risk identification, quantification, and mitigation engine can generate risk board reports. The risk board reports include, inter alia: a custom, risk mitigation decision-making roadmap. In this regard, the risk identification, quantification, and mitigation engine can function as an ERM program, performing real-time, on demand enterprise-wide risk assessments. For example, the risk identification, quantification, and mitigation engine can be integrated across, inter alia: technical Infrastructure (e.g. cloud-computing providers); application systems (e.g. enterprise applications focused on customer service and marketing, analytics, and application development); company processes (e.g. audits, assessments, etc.); business performance tools (e.g. management, etc.), etc. Examples of risk identification, quantification, and mitigation Engine methods, use cases and systems are now discussed.

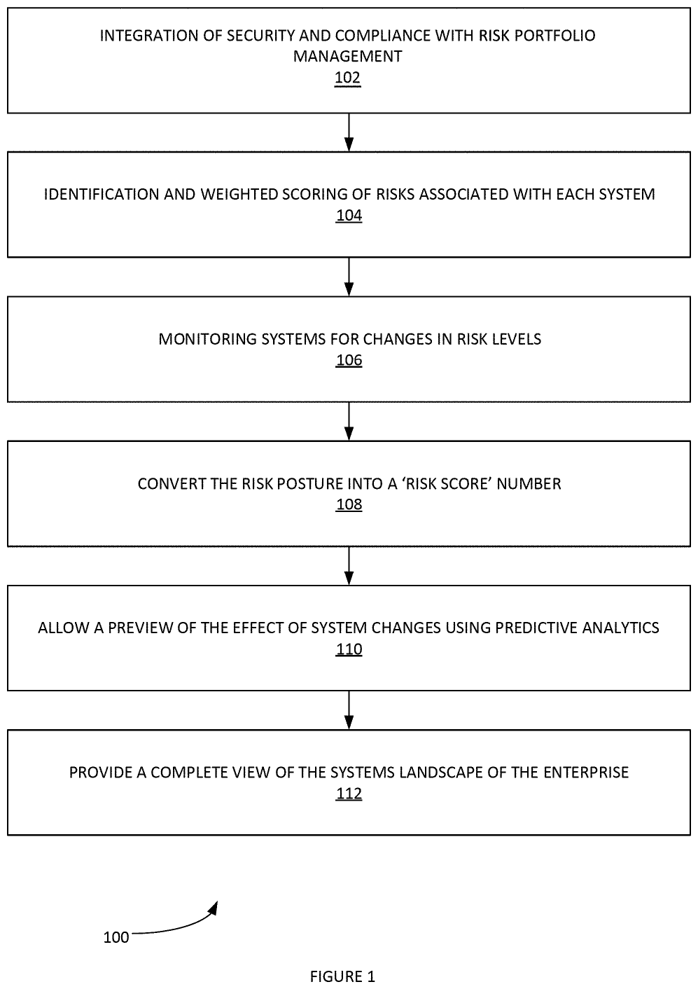

FIG. 1 illustrates an example process 100 for implementing risk identification, quantification, and mitigation engine delivery, according to some embodiments. Process 100 can enable an understanding of an enterprise's risk profile by providing a cross-organization risk assessment of current programs, risks, and resources. Process 100 can be used for risk mitigation. Process 100 can enable an enterprise to utilize AI and machine learning to understand their big data in real-time, thereby supporting the organization's business operations and objectives. Process 100 automation can be used to provide visibility into an enterprise's vertical businesses in real time (assuming for example, network and processing latencies). Additionally, enterprise stakeholders at all levels of an organization can use process 100 to identify important risk information specific to their individual roles and responsibilities in order to understand and optimize their risk profile. As noted, process 100 can utilize various data science algorithms and analytics, combined with AI and Machine Learning.

More specifically, in step 102, process 100 can implement the integration of security, privacy and compliance with a PPPM practice. In step 104, process 100 can calculate weighted scoring of risks associated with each enterprise system. It is noted that if manual inputs are not provided, then the scoring can be automatically completed using various specified machine learning techniques. These machine learning techniques can match similar risk inputs with an associated weight.

In step 106, process 100 can monitor the relevant enterprise systems for changes in risk levels. In step 106, process 100 can convert the risk level into a risk-score number. The objective risk-score number can help avoid any subjective assessment or understanding of the risk.

In step 110, process 100 can allow a preview of the effect of system changes using predictive analytics. In step 112, process 100 can provide a complete portfolio management view of the organization's systems across the enterprise.

Process 100 can provide an aggregated view of changes to security, privacy, and compliance risk. Process 100 can provide a consolidated view of risk associated with different assets and processes in one place. Process 100 can provide risk scoring and quantification. Process 100 can provide risk prediction. Process 100 can provide a CXO with a complete view of resource allocation and allow visibility into the various risk statuses and how all resources are aligned in real time.

Example Systems

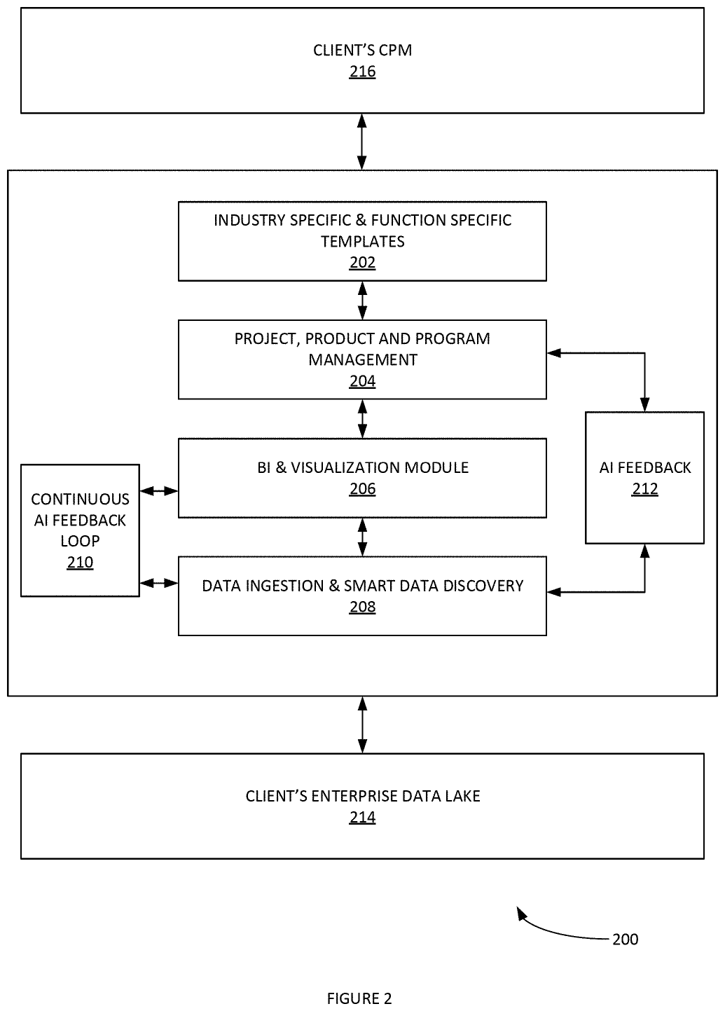

FIG. 2 illustrates an example risk identification, quantification, and mitigation engine delivery platform 200, according to some embodiments. Risk identification, quantification, and mitigation engine delivery platform 200 can include industry specific and function specific templates 202. The industry specific and risk specific templates 202 is a set of industry specific templates that have been created to define, identify, and manage the risk profiles of different industries. The list of target industries and associated compliance statutes can include, inter alia: financial services, pharmaceuticals, retail, insurance, and life sciences.

Furthermore, specified templates can include compliance templates. Compliance templates are created to calculate a risk score of the effectiveness of the controls established in a specified organization. The established controls are checked against the results of assessments performed by clients. Based on the client's inputs, the AI engine calculates the risk score by comparing the prior control effectiveness (impact and probability) to current control effectiveness. It is noted that the risk score of any control can be the decision indicator based on the risk severity. Risk severity can be provided at various levels. For example, risk severity levels can be defined as, inter alia: critical, high, medium, low, or very low.

Risk identification, quantification, and mitigation engine delivery platform 200 can include risk, product, and program management tool 204. Risk, product, and program management tool 204 can enable various user functionalities. Risk product and program management tool 204 can define a set of programs, risks, and products that are in-flight in the enterprise. Product and program management tool 204 can define the key stakeholders, risks, mitigation strategies against each of the projects, programs, and products. Project, product, and program management tool 204 can identify the high-level resources (e.g. personnel, systems, etc.) associated with the product, project, or program. Project, product, and program management tool 204 can provide the ability to define the changes in the enterprise system and therefore associate them to potential changes in risk and compliance posture.

Risk identification, quantification, and mitigation engine delivery platform 200 can include BI and visualization module 206. BI and visualization module 206 can provide a dashboard and/or other interactive modules/GUIs. BI and visualization module 206 can present the user with an easy to navigate risk management profile. The risk management profile can include the following examples among others. BI and visualization module 206 can present a bird's eye view of the risks, based on the role of the user. BI and visualization module 206 can present the ability to drill into the factors contributing to the risk profile. BI and visualization module 206 can provide the ability to configure and visualize the risk as a risk score number using proprietary calculations. BI and visualization module 206 can provide the ability to adjust the weights for the various risks, with a view to perform what-if analysis. The BI and visualization module 206 can present a rich collection of data visualization elements for representing the risk state.

Risk identification, quantification, and mitigation engine delivery platform 200 can include data ingestion and smart data discovery engine 208. Data ingestion and smart data discovery engine 208 engine can facilitate the connection with external data sources (e.g. Salesforce.com, AWS, etc.) using various APIs interface(s) and ingest the data into the tool. Data ingestion and smart data discovery engine 208 engine can provide a definition of the key data elements in the data source that are relevant to risk calculation, that automatically matches the elements with expected elements in the system using AI. Data ingestion and smart data discovery engine 208 can provide the definition of the frequency with which data can be ingested.

It is noted that a continuous AI feedback loop 210 can be implemented between BI and visualization module 206 and data ingestion and smart data discovery engine 208. Additionally, an AI feedback 212 can be implemented between project, product, and program management tool 204 and data ingestion and smart data discovery engine 208. Risk identification, quantification, and mitigation engine delivery platform 200 can include client's enterprise data applications and systems 214. Client's enterprise data applications and systems 214 can include CRM data, RDBMS data, project management data, service data, cloud-platform based data stores, etc.

Risk identification, quantification, and mitigation engine delivery platform 200 can provide the ability to track the effectiveness of the controls. Risk identification, quantification, and mitigation engine delivery platform 200 can provide the ability to capture status of control effectiveness at the central dashboard to enable the prioritization of decision actions enabled by AI scoring engine (e.g. AI/ML engine 908, etc.). Risk identification, quantification, and mitigation engine delivery platform 200 can provide the ability to track the appropriate stakeholders based on the controls effectiveness for actionable accountability.

Risk identification, quantification, and mitigation engine delivery platform 200 can define a super administrator (e.g. ‘Super Admin’). The Super Admin can have complete root access to the application. In addition, a Super Admin can have complete access to an application with the exception of deletion permissions. In this version, the System Admin can define and manage all the risk models, users, configuration settings, automation etc.

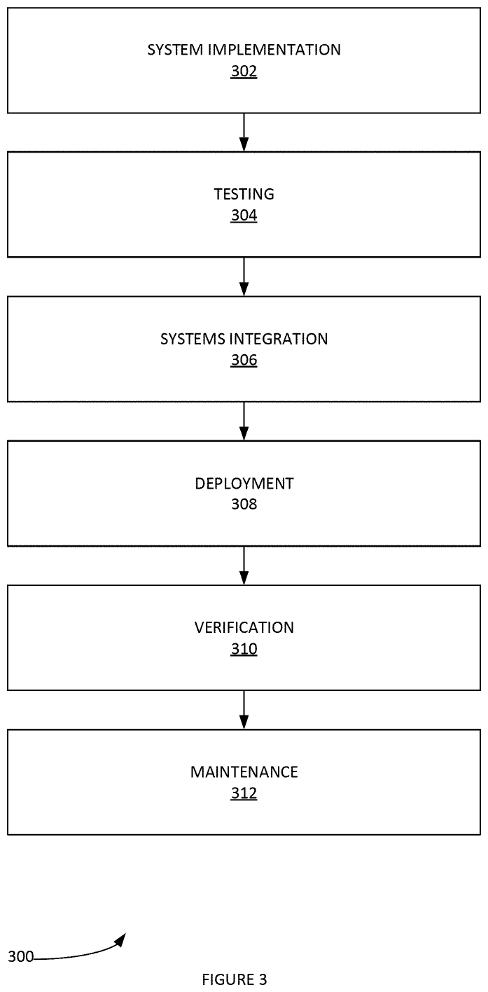

FIG. 3 illustrates an example process 300 for implementing risk identification, quantification, and mitigation engine delivery platform 200, according to some embodiments. In step 302, process 300 can perform System Implementation. More specifically, process 300 can, after implementing the system, define a super administrator. The super administrator can have the complete root access of the application. The super administrator may not be used for day-to-day operations in some examples. In one example, the process 300 can define a system administrator to complete access to the entire application, except deletion. In this way, system administrators can define and manage all the Risk Models, Users, Configuration Settings, Automation etc. Additional documentation can be provided as part of implementing the system.

In step 304, process 300 can perform testing operations. The risk identification, quantification, and mitigation engine delivery platform 200 can be tested in the non-production environment in the organization (e.g. staging environment) to ensure that the modules function as expected and that they do not create any adverse effect on the enterprise systems. Once verified, the system can be moved to the production environment.

In step 306, process 300 can implement client systems integration. The risk identification, quantification, and mitigation engine delivery platform 200 includes a standard set of APIs (e.g. connectors) to various external systems (e.g. AWS, Salesforce, Azure, Microsoft CRM). This set of APIs includes the ability to ingest the data from the external systems. The set of APIs are custom built and form a unique selling point of this system. Some organizations/entities have proprietary systems for which connectors are to be built. Once the connectors are built and deployed, the data from these systems can be fed into the internal engine and be part of the risk identification, monitoring and scoring process.

In step 308, process 300 can perform deployment operations. Deployment of risk identification, quantification, and mitigation engine delivery platform 200 enables the organization/enterprise and the stakeholders to identify and score the risk including the mitigation and management of the risk. The deployment process includes, inter alia, the following tasks. Process 300 can identify the environment in which the risk identification, quantification, and mitigation engine delivery platform 200 can be deployed. This can be a local environment within the De-Militarized Zone (DMZ) inside the firewall and/or any external cloud environment like AWS or Azure. Process 300 can scope out the system related resources (e.g. web/application/database servers including the configuration settings). Process 300 can define the stakeholders (e.g. C-level executives, administrators, users etc.) with a specific focus on security and privacy needs and the roles to manage the application in the organization.

In step 310, process 300 can perform verification operations. Verification can be a part of validating the risk identification, quantification, and mitigation engine delivery platform 200 in the organization as it is deployed and implemented. In the verification process, the stakeholders orient themselves towards scoring the risks (as opposed to providing subjective conclusions). This becomes a step in the overall success and adaptability of the application as inclusive as possible on a day-to-day basis.

In step 312, process 300 can perform maintenance operations. The technical maintenance of the system can include the step of monitoring the external connectors to ensure that the connectors are operating effectively. The step can also add new external systems according to the needs of the organization/enterprise. This can be completed using internal technical staff and staff assigned to the risk identification, quantification, and mitigation engine delivery platform 200, depending upon complexity and expertise level involved.

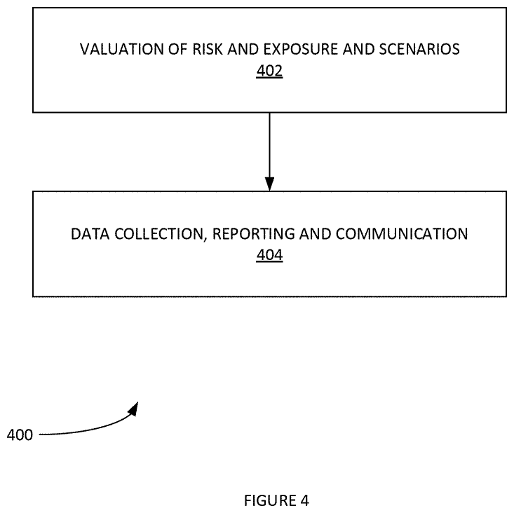

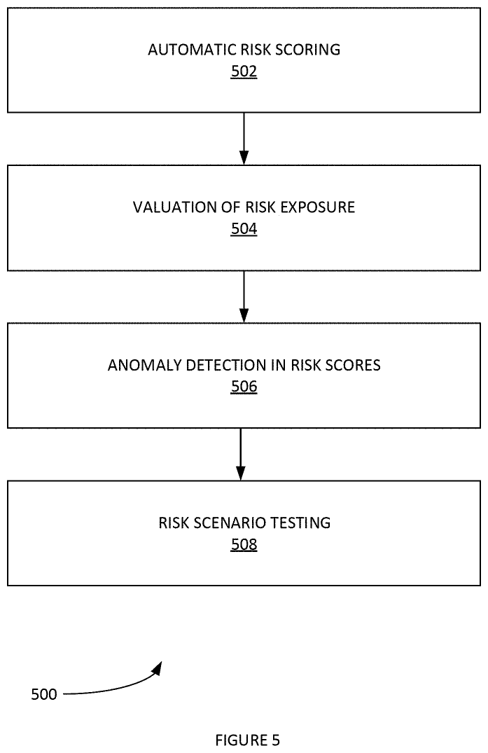

FIG. 4 illustrates an example risk assessment process 400, according to some embodiments. Process 400 can be used for accurate scoring of risk and determining financial exposure and remediation costs to an enterprise. Process 400 can combine multiple risk scores to provide an aggregated view across the enterprise.

In step 402, process 400 can implement accurate calculation of risk exposure and scenarios. In one example, process 400 can use process 500 to implement accurate calculation of risk exposure and scenarios.

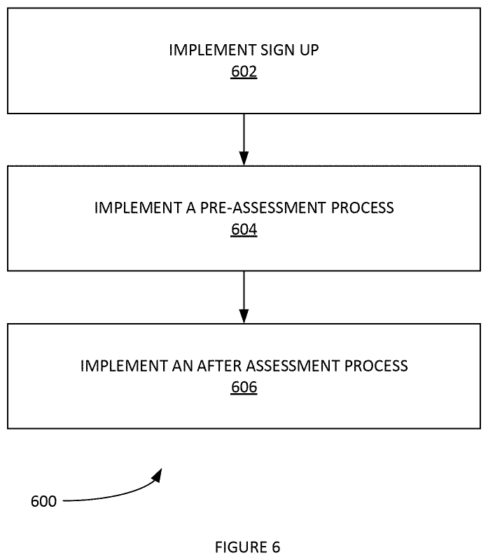

In step 502, process 400 can use process 600 to implement step 502. FIG. 6 illustrates an example of automatic risk scoring process 600, according to some embodiments. Process 600 can calculate risk scores. The risk scores can determine the severity of the risk levels for an organization. Risk scores can be calculated and displayed in a customizable format and with a frequency that meets a specific client's needs.

In step 602, process 600 can implement a sign-up process for a customer entity. When the customer signs up, process 600 can obtain various basic information about the industry that the customer entity operates in. Process 600 can also obtain, inter alia, revenue, employee population size details, regulations that are applicable, the operational IT systems and the like. Based on the data collected from other customers in the same industry and customer size, the risk score is arrived upon based on Machine Learning Algorithms that calculate a baseline for the industry (industry benchmarking).

In step 604, process 600 can implement a pre-assessment process(es). Based on the needs of the industry and/or for the entity (e.g. a company, educational institution, etc.), the customer selects controls that are to be assessed. Based on the customer's selection, process 500 can calculate a risk score. The risk score is based on, inter alia, a set of groupings of the risks which may have impact on the customer's security and data privacy profile. The collective impacts and likelihoods of the parts of the compliance assessments that are not selected can determine an upper level of the risk score. This can be based on pre-learned machine learning algorithms.

In step 606, process 600 can implement an after-assessment process(es). The after-assessment process(es) can relate to the impact of grouping of risks that create an exponential impact. The after-assessment process(es) can be based on the status of the assessment of the risk score. The after-assessment process(es) can be determined based on machine-learning algorithms that have been trained on data that exists on similar customer assessments.

Returning to process 500, in step 504, process 500 can implement a calculation of risk exposure assessment. It is noted that customers may wish to perform a cost-benefit analysis to assist with the decision to mitigate the risk using established processes. A dollar valuation of risk exposure provides a level of objectivity and justification for the expenses that the organization has to incur in order to mitigate the risk. Process 500 can use machine learning and existing heuristic data from organizations of similar size, industry and function and then extrapolate the data to determine the risk exposure, based on industry benchmarking, for the customer.

In step 506, process 500 can detect anomalies in risk scores. The risk scores are calculated according to the assessment results for a given period. Process 500 can then make comparisons with the same week of a previous month and/or same month/quarter of a previous year. While doing the comparisons, the seasonality of risk can be considered along with its patterns as the risk may be just following a pattern even if it has varied widely from the last period of assessment. A machine learning algorithm (e.g. a Recurrent Neural Network (RNN), etc.) can be trained to detect these patterns and predict the approximate risk score that the user is expected to obtain during the upcoming assessments, according to the existing patterns in the data. The RNN can be trained on different types of patterns like sawtooth, impulse, trapezoid wave form and step sawtooth. Visualizations can display predicted versus actual scores and alert the users of anomalies.

In step 508, process 500 can implement risk scenario testing. In one example, risks that are being assessed may have some dependencies and triggers that may cause exponential exposures. It is noted that dependencies can exist between the risks once discovered. Accordingly, weights can be assigned to exposures based on the type of dependency. Exposures can be much higher based on additive, hierarchical or transitive dependencies. Process 500 calculates the highest possible risk exposures with all the risk scenarios and attracts the users' attention where the most attention is needed. Process 500 can automatically identify non-compliance in respect of certain controls and generates a list of possible scenarios based on the risk dependencies, then bubble up the most likely scenarios for the user to review.

Returning to process 400 in step 404, process 400 can implement data collection, reporting and communication. Process 400 can obtain data that is used for assessment that is generated by the customer's computing network/system as an output. These features help the user to optimize data collection with the lowest possibility of errors on the input side, and on the output side provide the best possible reporting and communication capability. Process 400 can use process 700 to implement step 404.

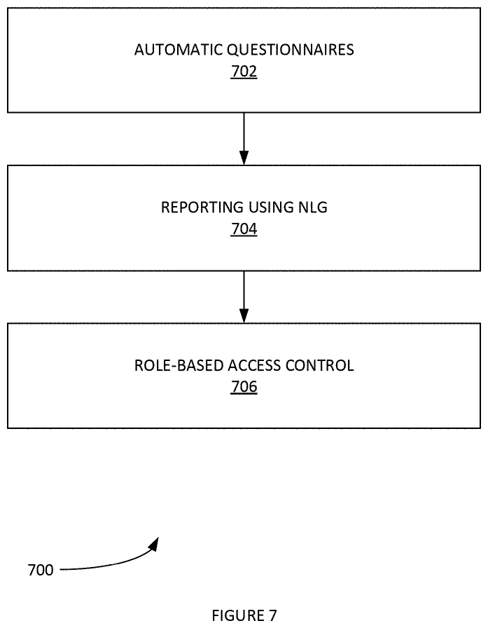

FIG. 7 illustrates an example data collection, reporting and communication process 700, according to some embodiments. In step 702, process 700 can create and implement automatic questionnaires. With the use of automatic questionnaires, any data in the customer system that is missing can be detected and flagged and, using NLG techniques, questions can be generated and sent in the form of a questionnaire that has to be filled in by the user/customer (e.g. a system administrator) to obtain the missing data required for risk scoring.

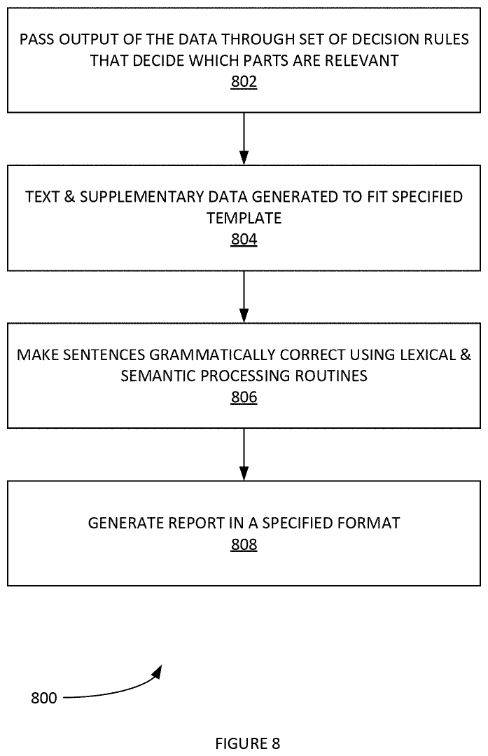

In step 704, process 700 can generate a report using NLG. It is noted that users may wish to obtain a snapshot of the data in a report format that can be used for communication in the organization at various levels. These reports can be automatically generated using a predetermined template for the report which is relevant to the client's industry. The report can be generated by process 800. FIG. 8 illustrates an example process 800 for generating a report using NLG, according to some embodiments.

In step 802, process 800 can use the output of the data. Process 800 can pass it through a set of decision rules that decide what parts of the report are relevant. In step 804, the text and supplementary data can be generated to fit a specified template. In step 806, process 800 can make the sentences grammatically correct using lexical and semantic processing routines. In step 808, the report can then be generated in any format (e.g. PDF, HTML, PowerPoint, etc.) as required by the user. The templates can be used to generate various dashboard views, such as those provided infra.

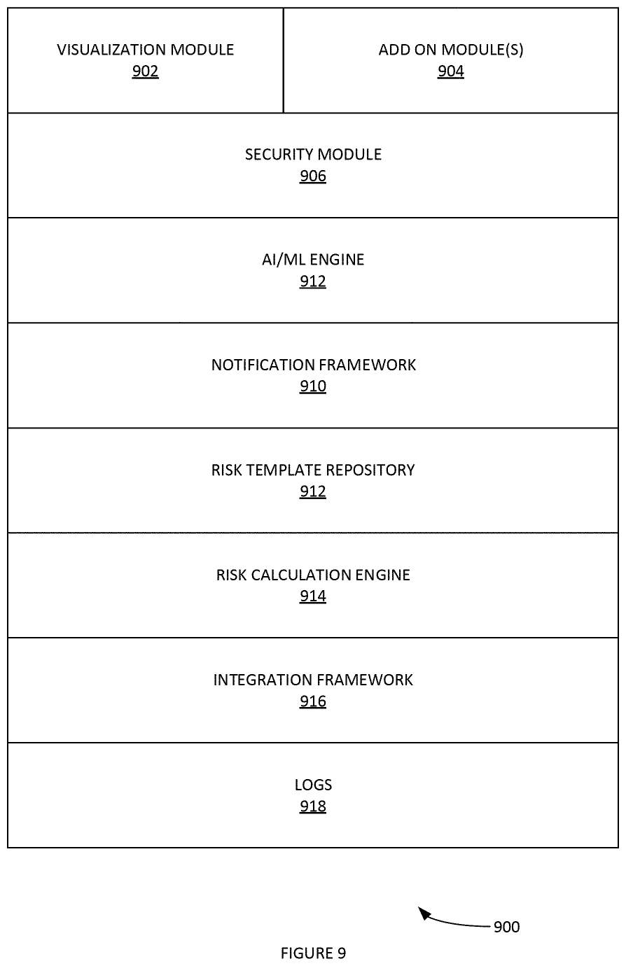

FIG. 9 illustrates additional information for implementing a risk identification, quantification, and mitigation engine delivery platform, according to some embodiments. As shown, a risk identification, quantification, and mitigation engine delivery platform 200 can be modularized with core capabilities and foundational components. These capabilities are available for all customers and initial license includes, inter alia: security, visualization, notification framework, AI/ML analytics-based predictive models, risk score calculation module, risk templates integration framework, etc. Risk identification, quantification, and mitigation engine delivery platform 200 can add various customizable risk models by category and/or industry that are relevant to the organization. These additional risk models can to the-core risk identification, quantification, and mitigation engine delivery platform 200 and/or can be licensed individually. These additional modules can be customized to a customer's requirements and needs.

As shown in the screen shots, risk identification, quantification, and mitigation engine delivery platform 200 provides a visual dashboard that highlights organizational risk based on defined risk models, for example compliance, system, security, and privacy. The dashboard allows users to aggregate and highlight risk as a risk score which can be drilled down for each of the models and then view risk at model level. As shown, users can also drill down into the model to view risk at a more granular detail.

Generally, in some example embodiments, risk identification, quantification, and mitigation engine delivery platform 200 can provide out of box connectivity with various products (e.g. Salesforce, Workday, ServiceNow, Splunk, AWS, Azure, GCP cloud providers, etc.), as well as ability to connect with any database or product with minor customization. Risk identification, quantification, and mitigation engine delivery platform 200 can consume the output of data profiling products or can leverage DLP for data profiling. Risk identification, quantification, and mitigation engine delivery platform 200 has a customizable notification framework which can proactively monitor the integrating systems to identify anomalies and alert the organization. Risk identification, quantification, and mitigation engine delivery platform 200 can track the lifecycle of the risk for the last twelve (12) months. Risk identification, quantification, and mitigation engine delivery platform 200 has AI/ML capabilities (e.g. see AI/ML engine 908 infra) to predict and highlight risk as a four (4) dimensional model based on twelve (12) month aggregate. The dimensions can be measured by color, size of bubble (e.g. importance and impact to organization/enterprises), cost to fix and risk definition. Risk identification, quantification, and mitigation engine delivery platform 200 includes an alerting and notification framework that can customize messages and recipients.

Risk identification, quantification, and mitigation engine delivery platform 200 can include various addons as noted supra. These addons (e.g. inventory trackers for retailers, controlled substance tracker for healthcare organizations, PII tracker, CCPA tracker, GDPR tracker) can integrate with common framework and are managed through common interface.

Risk identification, quantification, and mitigation engine delivery platform 200 can proactively monitor the organization at a user-defined frequency. Risk identification, quantification, and mitigation engine delivery platform 200 has the ability to suppress risk based on user feedback. Risk identification, quantification, and mitigation engine delivery platform 200 can integrate with inventory and order systems. Risk identification, quantification, and mitigation engine delivery platform 200 contains system logs. Risk identification, quantification, and mitigation engine delivery platform 200 can define rules by supported by Excel Templates. Risk identification, quantification, and mitigation engine delivery platform 200 can include various risk models that are extendable and customizable by the organization.

More specifically, FIG. 9 illustrates a risk identification, quantification, and mitigation engine delivery platform 200 with modularized-core capabilities and components 900, according to some embodiments. Modularized-core capabilities and components 900 can be implemented in risk identification, quantification, and mitigation engine delivery platform 200. Modularized-core capabilities and components 900 can include a customizable compliance AI tool (e.g. AI/ML engine 208, etc.). Modularized-core capabilities and components 900 can include PCI DSS controls applicable for organizations. Modularized-core capabilities and components 900 can also include GDPR controls, HIPAA controls, ISMS (includes ISO27001) controls, SOC2 controls, NIST controls, CCPA controls, etc. The use of these controls can be based on the various relevant applications for the customer(s). Modularized-core capabilities and components 900 can include a processing engine to obtain the status from organizations. Modularized-core capabilities and components 900 can provide a dashboard enabling the compliance stakeholders to take action based on the risk score (e.g. see visualization module 204 infra). These controls can be based on the various relevant applications for the customer(s). Modularized-core capabilities and components 900 can include a processing engine to obtain the status from organizations.

Modularized-core capabilities and components 900 can include a visualization module 902. Visualization module 902 can generate and manage the various dashboard view (e.g. such as those provided infra). Visualization module 902 can use data obtained from the various other modules of FIG. 9, as well as applicable systems in risk identification, quantification, and mitigation engine delivery platform 200. The dashboard can enable stakeholders to take action based on the risk score.

Add-on module(s) 904 can include various modules (e.g. CCPA Module, PCI module, GDPR module, HIPPA module, retail inventory module, FCRA module, etc.).

Security module 906 provides an analysis of a customer's system and network security systems, weaknesses, potential weaknesses, etc.

AI/ML engine 908 can present a unique risk score for the controls based on the historical data. AI/ML engine 908 can provide AI/ML Analytics based predictive models of risk identification, quantification, and mitigation engine delivery platform 200. For example, AI/ML 908 can present a unique risk score for the controls based on the historical data.

Notification Framework 910 generates notifications and other communications for the customer. Notification Framework 910 can create questionnaires automatically based on missing data. Notification Framework 910 can create risk reports automatically using Natural Language Generation (NLG). The output of Notification Framework 910 can be provided to visualization module 902 for inclusion in a dashboard view as well.

Risk Template Repository 912 can include function specific templates 202 and/or any other specified templates described herein.

Risk calculation engine 914 can take inputs from multiple disparate sources, intelligently analyze, and present the organizational risk exposure from the sources as a numerical score using proprietary calculations (e.g. a hierarchy using pre-learned algorithms in a ML context, etc.). Risk calculation engine 914 can perform automatic risk scoring after customer sign-up. Risk calculation engine 914 can perform automatic risk scoring before and after an assessment as well. Risk calculation engine 914 can calculate the monetary valuation of a risk exposure after the assessment process. Risk calculation engine 914 can provide a default risk profile set-up for an organization based on their industry and stated risk tolerance. Risk calculation engine 914 can detect anomalies in risk scores for a particular period assessed. Risk calculation engine 914 can provide a list of risk scenarios which can have an exponential impact based.

Integration Framework 916 can provide and manage the integration of security and compliance with a customer's portfolio management.

Logs 918 can include various logs relevant to customer system and network status, the operations of risk identification, quantification, and mitigation engine delivery platform 200 and/or any other relevant systems discussed herein.

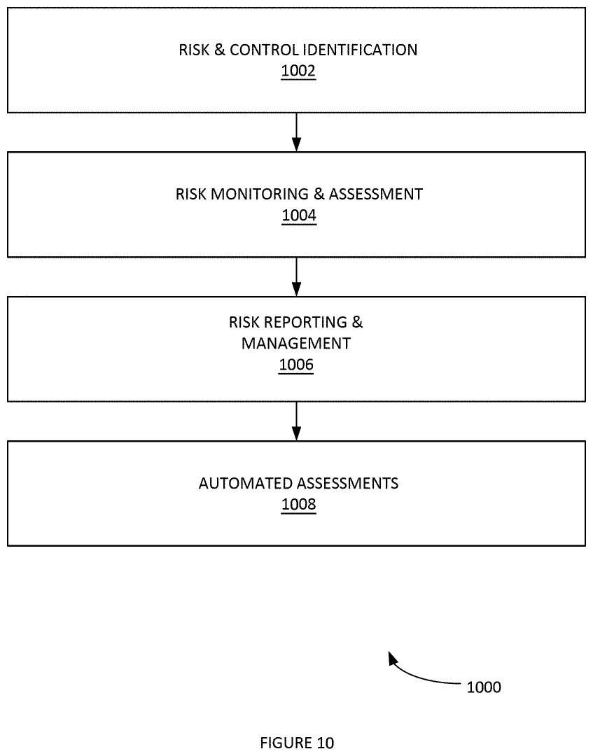

FIG. 10 illustrates an example process 1000 for enterprise risk analysis, according to some embodiments. In step 1002, process 1000 can implement risk and control identification. Risks and controls can be categorized by, inter alia: risk type, function, location, segment, etc. Owners and stakeholders can be identified. This can include identifying relevant COSO standards. This can include identifying and quantifying, inter alia: impact, likelihood of exposure in terms of cost, remediation cost, etc.

In step 1004, process 1000 can implement risk monitoring and assessment. Process 1000 can provide and implement various automated/manual standardized templates and/or questionnaires. Process 1000 can implement anytime on-demand alerts for pending/overdue assessments as well.

In step 1006, process 1000 can implement risk reporting and management. For example, process 1000 can provide a risk scoring risk analytics dashboard, customizable widgets alerts and notifications. These can include various AI/ML capabilities.

In step 1008, process 1000 can generate automated assessments (e.g. of system/cybersecurity risk, AWS®, GCP®, VMWARE®, AZURE®, SFDC®, SERVICE NOW®, SPLUNK® etc.). This can also include various privacy assessments (e.g. GDPR-PII, CCPA-PII, PCI-DSS-PII, ISO27001-PII, HIPAA-PII, etc.). Operational risk assessment can be implemented as well (e.g. ARCHER®, ServiceNow®, etc.). Process 1000 can review COMPLIANCE (E.g. GDPR, CCPA, PCI-DSS, ISO27001, HIPAA, etc.). Manual assessments can also be used to validate/supplement automated assessments.

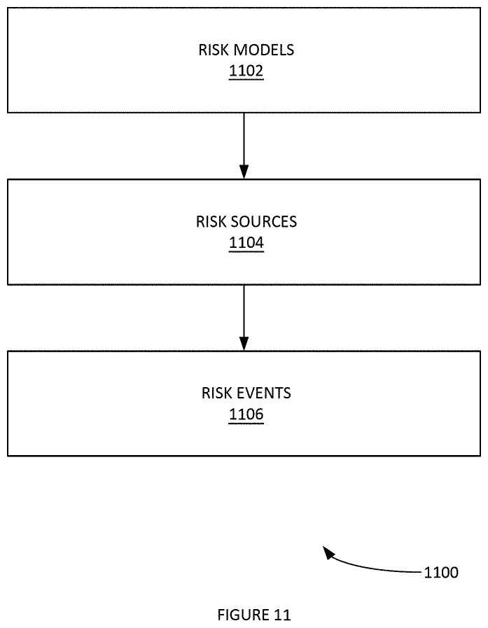

FIG. 11 illustrates an example process 1100 for implementing a risk architecture, according to some embodiments. In step 1102, process 1100 can generate risk models. This can provide a quantitative view of an organization's enterprise level risk categorization.

In step 1104, process 1100 provides a list of risk sources. These can be any items exposing an enterprise to risk. In step 1106, process 1100 can provide risk events. This can include monitoring and identification of risk.

Agent System for Hardware Risk Information

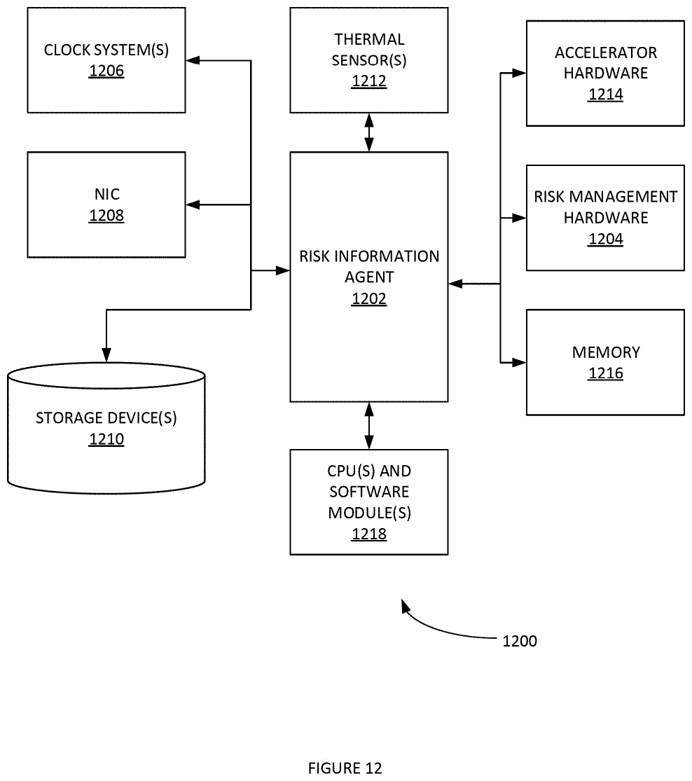

FIG. 12 illustrates an example hardware risk information system 1200 for implementing an agent system for hardware risk information, according to some embodiments. Hardware risk information system 1200 identifies risk by tracking the hardware assets that have been deployed by an enterprise. For example, hardware risk information system 1200 can track the following hardware asset variables. Hardware risk information system 1200 can track time since the enterprise asset was switched on. Hardware risk information system 1200 can track continuous usage of the enterprise asset. Hardware risk information system 1200 can track the number of restarts of the hardware system(s) of the enterprise asset. Hardware risk information system 1200 can track the physical/thermal conditioning of the enterprise asset. Hardware risk information system 1200 can track specified software/data assets that are dependent on the hardware asset as well.

FIG. 12 illustrates an example of hardware risk information system 1200 utilizing a local risk information agent 1202. Local risk information agent 1202 runs on the hardware systems of the enterprise assets. Local risk information agent 1202 manages the collection of the information necessary to calculate the risk score discussed supra.

Local risk information agent 1202 collects this information from various specified hardware sources operative in the enterprise assets. For example, local risk information agent 1202 collects clock related information from clock system(s) 1106. Local risk information agent 1202 can collect current time to calculate the time since switch-on and/or time since last restart and the like from a real-time clock.

Local risk information agent 1202 can collect information from the NIC 1108. For example, local risk information agent 1202 can obtain statistics on the usage of various computer network(s), network traffic spikes and/or any other changes in the network traffic going in and out of the hardware asset being monitored.

Local risk information agent 1202 can collect information from various enterprise assets data storage system(s) 1110 (e.g. hard drive, SSD systems, other data storage systems, etc.). Local risk information agent 1202 can collect usage statistics of the data based on how much the enterprise asset is accessing the data storage 1110 on the enterprise asset.

Local risk information agent 1202 can collect information from an accelerator hardware system(s) 1114. Local risk information agent 1202 can collect information about acceleration of certain software functions including, inter alia: machine learning functions, graphic functions, etc. Local risk information agent 1202 can use special-purpose hardware that is attached to the enterprise asset.

Local risk information agent 1202 can collect information from memory systems 1116. It is noted that high memory usage can signal the extreme usage of a hardware asset.

Local risk information agent 1202 can collect information from CPU and software modules 1118 of the enterprise assets. High CPU usage may also signify extreme usage of relevant elements of the hardware systems of the enterprise asset. Local risk information agent 1202 can collect information from specified software modules and their associated criticality information. Local risk information agent 1202 can collect information from thermal sensors that may have an important role in finding how fast the modules may degrade.

Local risk information agent 1202 can utilize risk management hardware device 1204 for analyzing the collected information. After collecting the risk information from the enterprise asset's hardware and on a specified basis (e.g. at a specified period), local risk information agent 1202 agent pushes the collected information onto risk management hardware device 1204. Risk management hardware device 1204 serves as a repository for all the risk parameters for the enterprise asset.

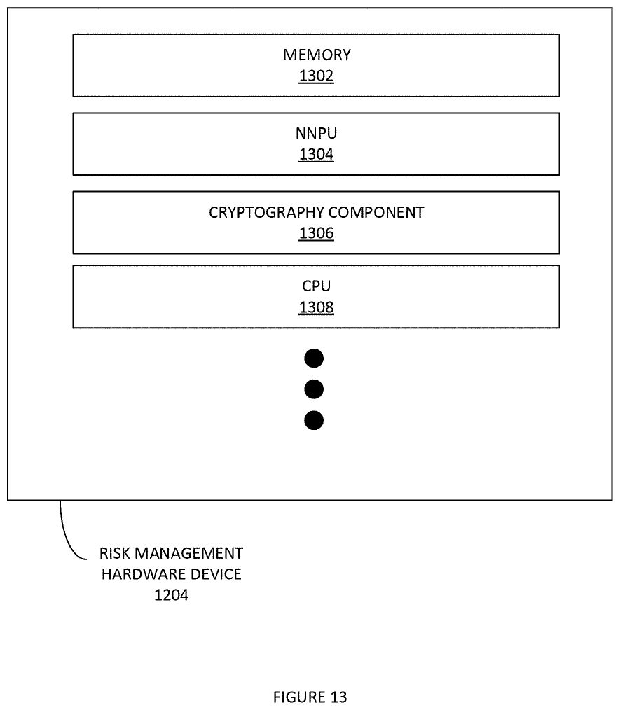

FIG. 13 illustrates an example risk management hardware device 1204 according to some embodiments. Risk management hardware device 1204 includes a memory 1302. Memory 1302 can be persistent for storing the risk parameters stored for the long term. Risk management hardware device 1204 includes a low-power Neural Network Processing Unit (NNPU) 1304. NNPU 1304 can be used for local AIML processing and summarization operations. These can include various processes provided supra.

Risk management hardware device 1204 can include a cryptography component 1306. Cryptography component 1306 can be utilized for securing the data using encryption while sending the collected data and/or any analysis performed by risk management hardware device 1204 into and out of the risk management hardware device 1204.

Risk management hardware device 1204 can include a lightweight CPU 1308. CPU 1308 can run instructions for all tasks performed locally on risk management hardware device 1204. These tasks can include, inter alia: data copies, IO with the NNPU, the cryptographic component and memory, etc.

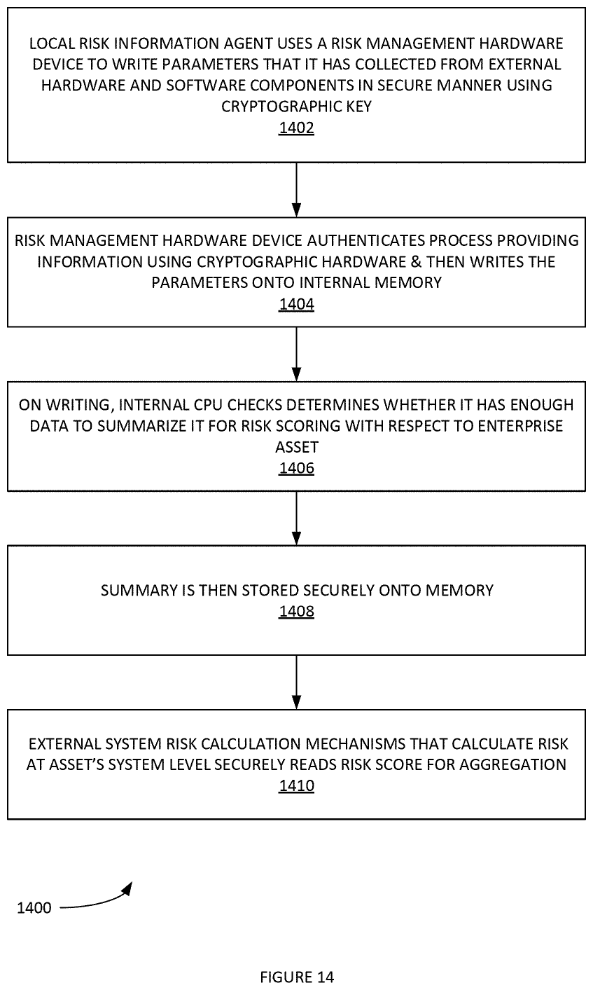

FIG. 14 illustrates an example process 1400 for using a risk management hardware device for calculating the risk score of an enterprise asset, according to some embodiments. In step 1402, on a periodic basis, a local risk information agent (e.g. local risk information agent 1202) uses a risk management hardware device to write the parameters that it has collected from the external hardware and software components in a secure manner using the cryptographic key supplied to it. In step 1404, the risk management hardware device authenticates the process providing the information using the cryptographic hardware and then writes the parameters onto the internal memory. In step 1406, on writing, the internal CPU checks determines whether it has enough data to summarize it for risk scoring with respect to the enterprise asset. If ‘yes’, then the risk management hardware device sends the data to the NNPU for creating a risk score based on the current chunk of data and the older risk scores. In step 1408, the summary is then stored securely onto memory. In step 1410, the external system risk calculation mechanisms that calculate risk at the asset's system level can now securely read this risk score for aggregation.

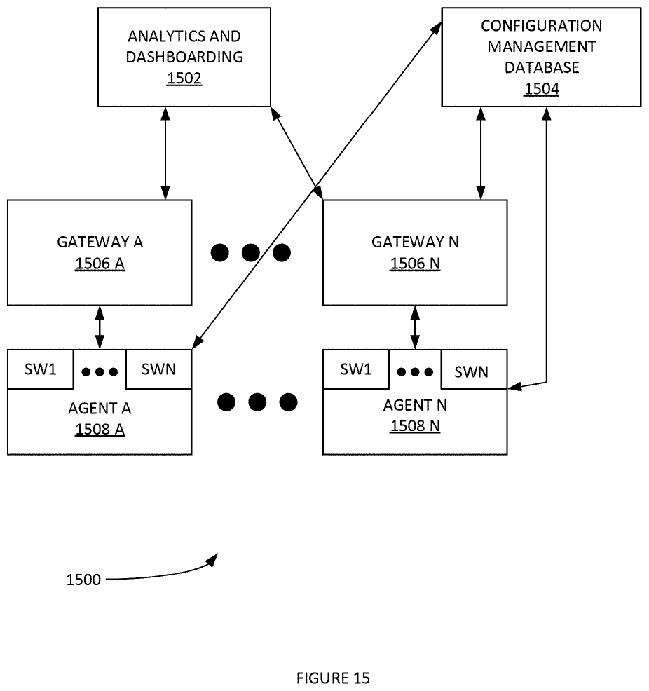

FIG. 15 illustrates a system of Risk Management Software Architecture 1500 according to some embodiments. Agents 1508 A-N can sit on the hardware components of a set of enterprise assets. Agents 1508 A-N are installed on all the machines in the enterprise asset to summarize all the risk parameter information onto the risk management hardware device 1204.

Gateways 1506 A-N can collect the risk scores for a portion of the enterprise architecture from the agents attached to the hardware components. Gateways 1506 A-N can summarize this information and present it to Analysis and Dashboarding component 1502. Gateways 1506 A-N can collect the information that is stored on through the agents and combine this information with the map of all the software components using a Configuration Management DataBase (CMDB) 1504 and have a combined Risk Map. The Risk Map is then read by Analytics and Dashboarding.

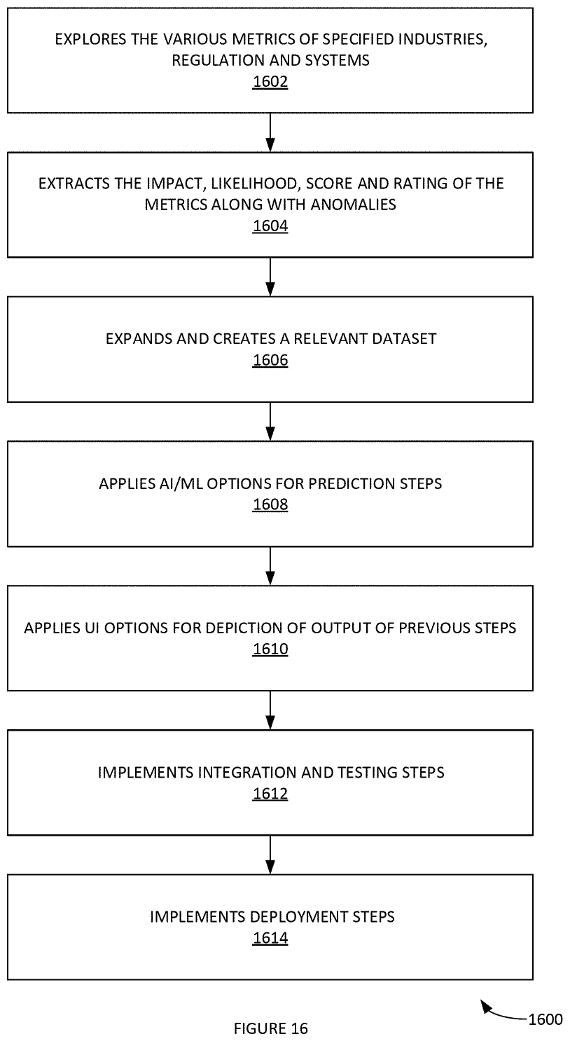

Analysis and Dashboarding component 1502 can summarize risk data in a user interface and use API(s) to present various scoring, exposure, remediation, trends, and progression of the entire enterprise by collecting data from all the agents and gateways. Analysis and Dashboarding component 1502 can use a specified AI/ML algorithm to optimize analysis and presentation of the information. Analytics and Dashboarding component 1502 can provide users insights based on the data collected from the manual and electronic components of system 1500. The dashboard uses the following shallow learning (e.g. with deep-learning topologies) in neural networks for dashboarding as provided in FIGS. 16-26. Accordingly FIGS. 16-26 illustrate example processes implemented using neural networks for dashboarding, according to some embodiments.

FIG. 16 illustrates an example process 1600 implementing automated risk scoring, risk exposure, and risk re-mediation costs according to some embodiments. The automated risk scoring uses advanced machine learning techniques to arrive at the risk score from the control data that is gathered from IT plant (networks, servers, devices etc.), and from questionnaires that are being assessed for that company. The AI/ML model uses a combination of inbuilt combinations (that may elevate the risk levels) and triggering risk categories to come up with the summary risk scores per category of risk and for the higher-level risk score for the company. The automated risk scoring system learns the rules directly from the data and uses it to score future assessments.

More specifically, in step 1602, process 1600 explores the various metrics of specified industries, regulations and systems and selects the right set of AI/ML modules that would be relevant. In step 1604, process 1600 derives the impact, likelihood, and risk score of the metrics along with anomalies. In step 1608, process 1600, applies AI/ML options for prediction steps. In step 1610, process 1600 applies UI options for depiction of output of previous steps. In step 1612, process 1600 implements integration and testing steps. In step 1614, process 1600 implements deployment steps. The summarization for various risk categories and the highest-level risk score for the company is also generated.

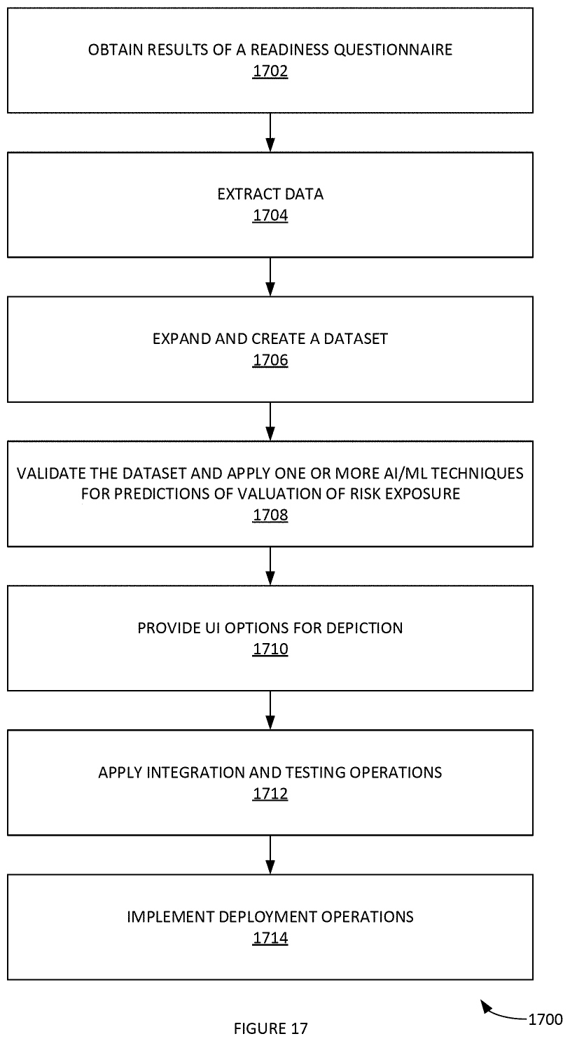

FIG. 17 illustrates an example process 1700 for determining a valuation of risk exposure, according to some embodiments. With a company's revenue, number of employees, number of systems, applications, devices, and other company size parameters along with, risk tolerance and risk score of the company using the present system can be able to predict the risk exposure of the company using AI/ML techniques.

More specifically, in step 1702, process 1700 can provide and obtain results of a readiness questionnaire. In step 1704, process 1700 can extract data related to, inter alia: control, severity, cumulations, USD exposure range, etc. In step 1706, process 1700 expands and creates a dataset (e.g. data set obtained from readiness questionnaires, etc.). In step 1708, process 1700 can validate the dataset and apply one or more AI/ML techniques for predictions of valuation of risk exposure. In step 1710, process 1700 can provide UI options for depiction. In step 1712, process 1700 can apply integration and testing operations. In step 1714, process 1700 implements deployment operations.

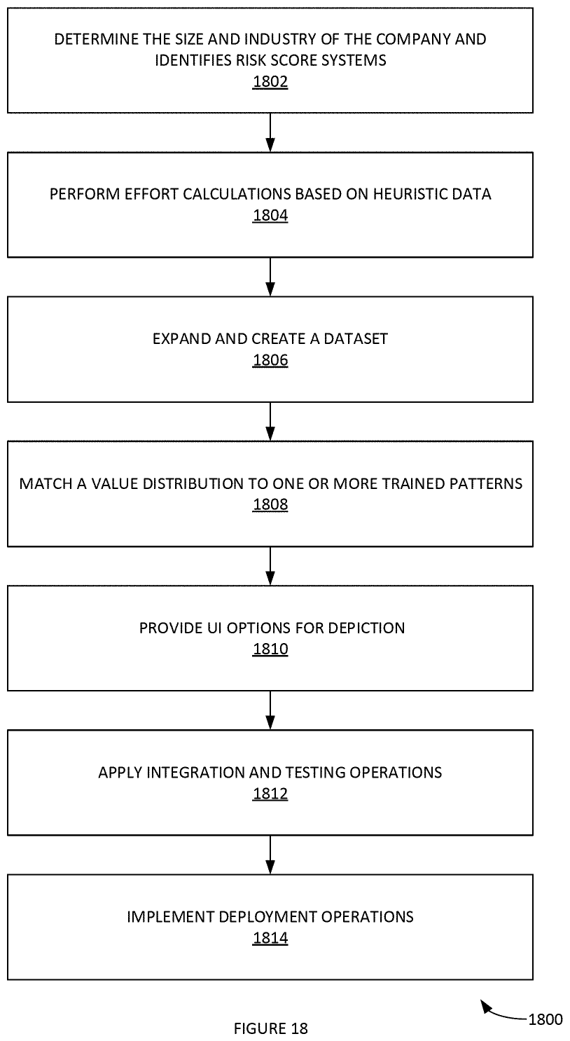

FIG. 18 illustrates an example process 1800 for determining a risk remediation cost, according to some embodiments. The risk remediation cost analysis combines the experience of industry professionals, in addition to revenue, number of employees, number of systems, risk tolerance of the company and other company size parameters. Hardware risk information system 1200 can use AI/ML algorithms to combine these to generate/calculate the final risk remediation costs.

More specifically, in step 1802, process 1800 determines the size and industry of the company and identifies risk score systems. In step 1804, process 1800 performs effort calculations based on heuristic data. This data is sent to step 1806, that expands and creates a dataset. In step 1808, process 1800 matches a value distribution to one or more trained patterns. In step 1810, process 1800 can provide UI options for depiction. In step 1812, process 1800 can apply integration and testing operations. In step 1814, process 1800 implements deployment operations.

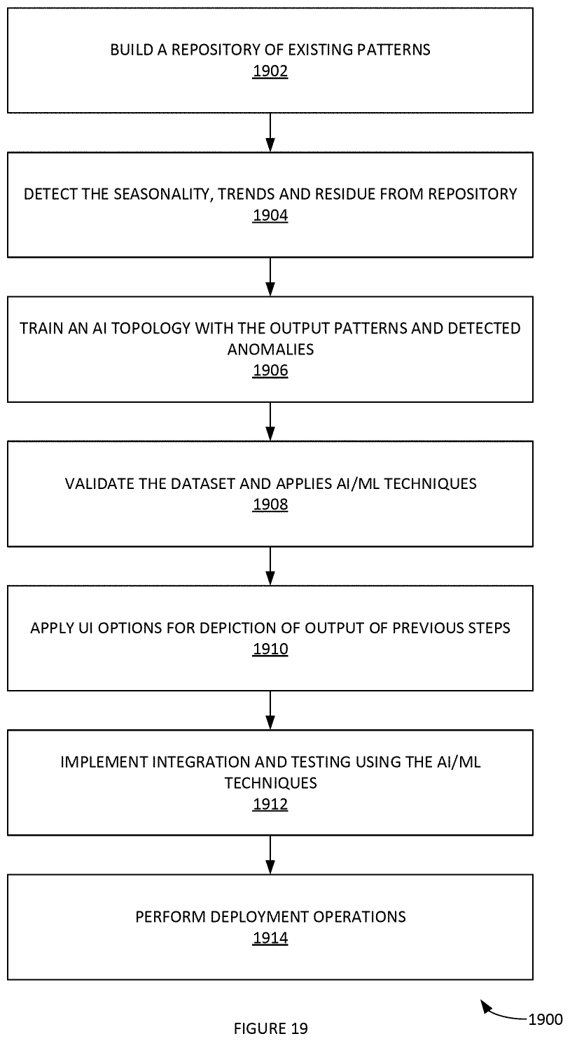

FIG. 19 illustrates an example process 1900 for anomaly detection in risk scores, according to some embodiments. Hardware risk information system 1200 can use trend analysis and detection of risk scores by using AI/ML algorithms to predict the risk scores for the future months. A drastic difference may lead to alerts triggered in the system.

More specifically, in step 1902, process 1900 builds a repository of existing patterns. In step 1904, process 1900 detects the seasonality, trends, and residue from the repository. This step can also detect anomalies. In step 1906, process 1900 trains an AI topology with the output patterns and detected anomalies of step 1904. In step 1908, process 1900 validates the dataset and applies AI/ML techniques. In step 1910, process 1900 applies UI options for depiction of output of previous steps. In step 1912, process 1900 implements integration and testing using the AI/ML techniques. In step 1914, process 1900 performs deployment operations.

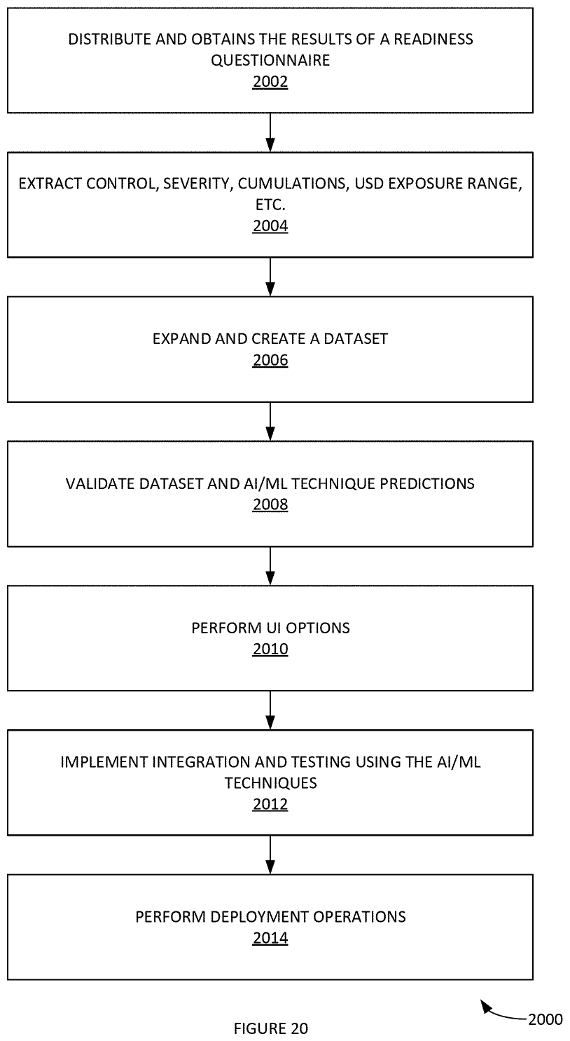

FIG. 20 illustrates an example process 2000 for industry benchmarking, according to some embodiments. Hardware risk information system 1200 can use industry benchmarks that are summarized by AI/ML algorithms. Hardware risk information system 1200 can use data that is spanning all industries, with companies of various sizes.

In step 2002, process 2000 distributes and obtains the results of a readiness questionnaire. In step 2004, process 2000 extracts control, severity, cumulations, USD exposure range, etc. from input to readiness questionnaire. In step 2006, process 2000 expands and creates a dataset (e.g. dataset generated from previous steps and/or other processes discussed herein, etc.). In step 2008, process 2000 validates dataset and AI/ML technique predictions. In step 2010, process 2000 performs UI options for depiction of output of previous steps. In step 2012, process 2000 performs integration and testing. In step 2014, process 2000 performs deployment operations.

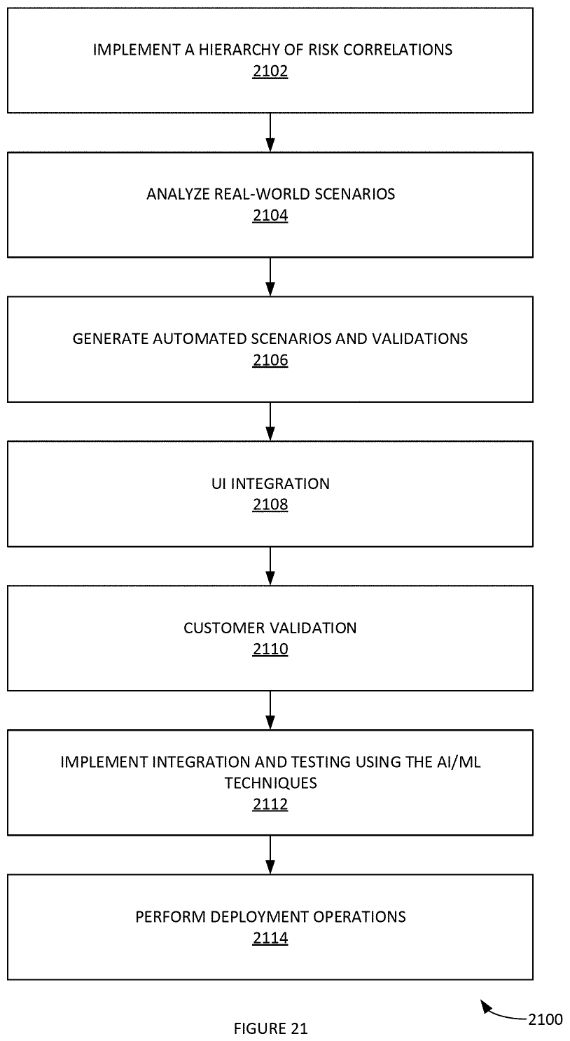

FIG. 21 illustrates an example process 2100 for risk scenario testing, according to some embodiments. Hardware risk information system 1200 can utilize knowledge of risks that are interdependent and may trigger each other. For example a network risk may put an application at risk, and this may create a data risk that may lead to a breach that is an operational risk and finally it may cause a risk to the brand image. The entire system of risk and their dependencies and what if scenarios can be created that can test if the system is resilient and the right sentinels for risk are placed in the system.

More specifically, in step 2102, process 2100 implements a hierarchy of risk correlations. In step 2104, process 2100 analyzes real-world scenarios. In step 2106, process 2100 generates automated scenarios and validations. UI integration is implemented in step 2108. Customer validation is implemented in step 2110. In step 2112, process 2100 applies integration and testing. In step 2114, process 2100 performs deployment operations.

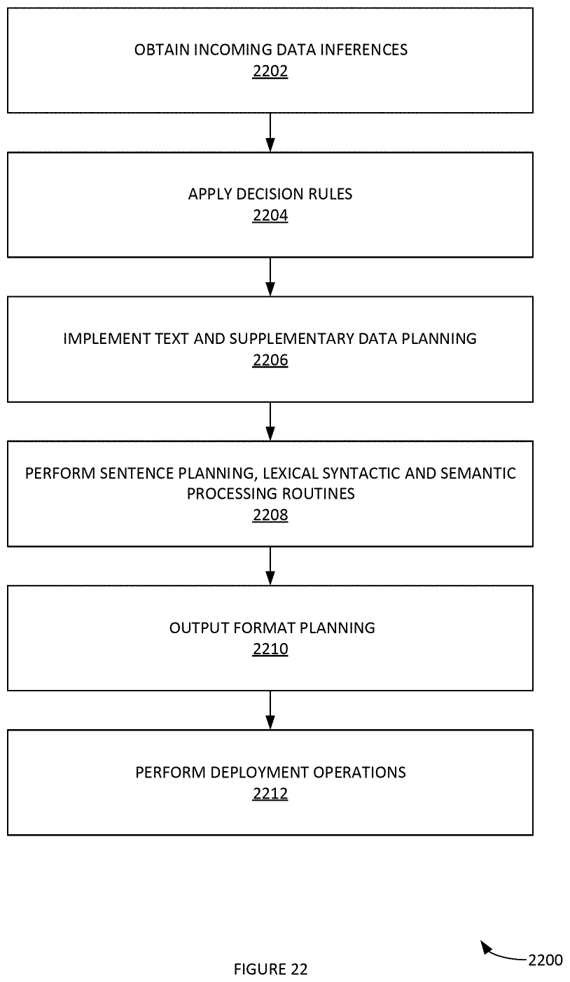

FIG. 22 illustrates an example process 2200 implemented using automatic questionnaires and NLG, according to some embodiments. After the assessments are completed, there may be certain gaps in the data to come up with the risk scores, risk exposure and risk remediation costs. Using NLG techniques, questions are created that fill gaps, if any. The questions may then be sent to the appropriate personnel for completion.

More specifically in step 2202, incoming data inferences are obtained. In step 2204, process 2200 applies decision rules. Text and supplementary data planning are implemented in step 2206. In step 2208, process 2200 performs sentence planning, lexical syntactic and semantic processing routines. In step 2210, output format planning is implemented. In step 2212, process 2200 performs deployment operations.

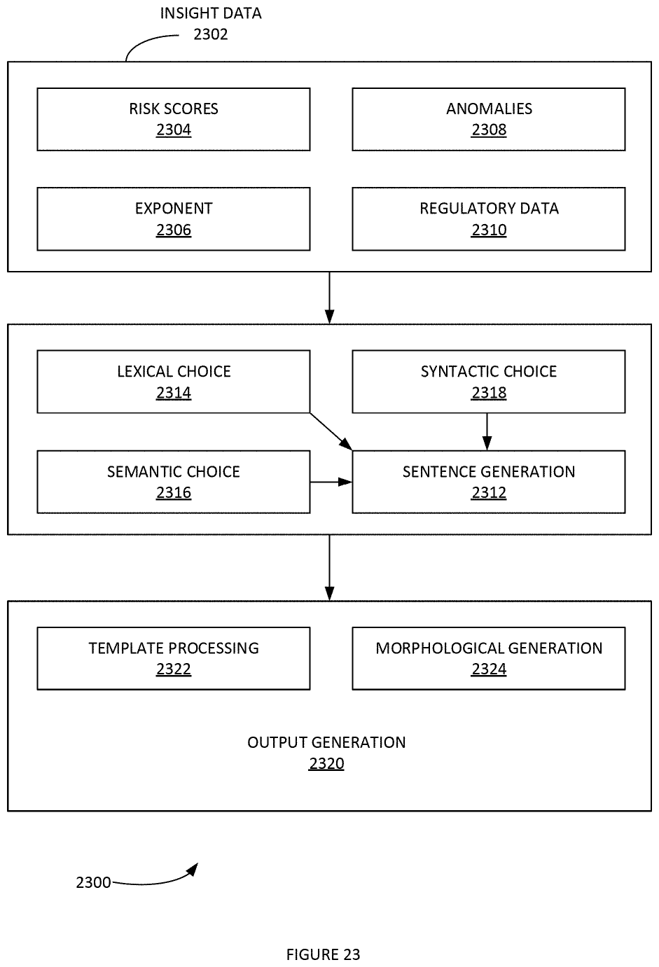

FIG. 23 illustrates an example process 2300 implemented using reporting using NLG, according to some embodiments. A report is generated (e.g. by hardware risk information system 1200) for senior executives, auditors and other stakeholders setting out risk results. For coming up with a natural language report using the insights that is generated by the system, templates may be used to turn the insights into actionable recommendations in a report. This is achieved by using artificial intelligence-based NLG techniques hardware risk information system 1200 can use the insights, and the templates and generate a human readable report. Process 2300 can report output of 2200 using NLG operations.

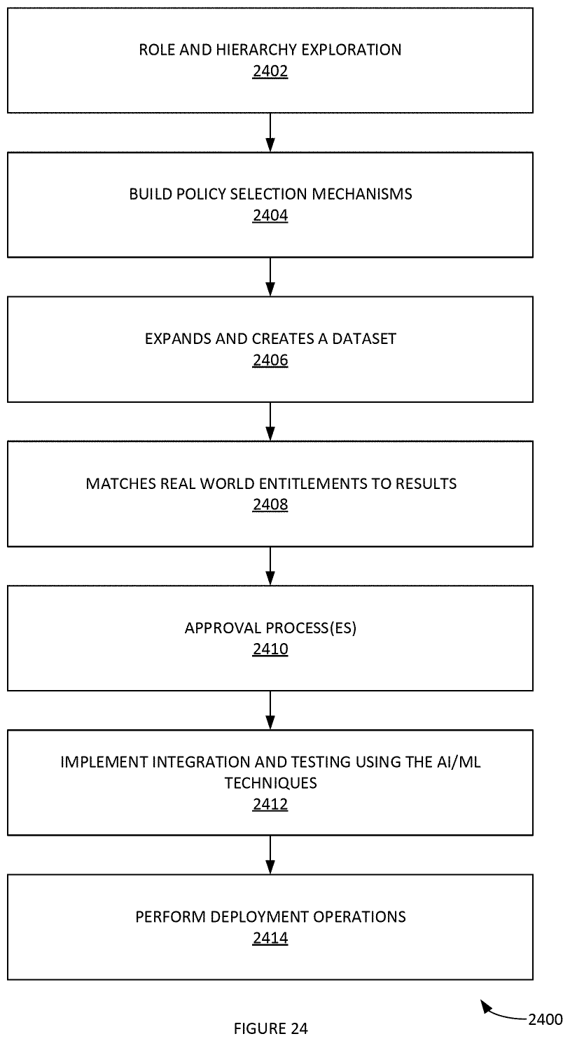

FIG. 24 illustrates an example process 2400 of automatic role assignment for role-based access control, according to some embodiments. The hierarchies in between the CXO organizations may be very different in companies. Accordingly, an automatic way to provide a role-based access control can be to use the hierarchies and using correlation techniques in artificial intelligence to provide roles for users of the system based on their hierarchies.

In step 2402, process 2400 implements role and hierarchy exploration. In step 2404, process 2400 builds policy selection mechanisms. In step 2406, process 2400 expands and creates a dataset from the outputs of step 2402 and 2404. In step 2408, process 2400 matches real world entitlements to results. Approval process(es) are deployed in step 2410. In step 2412, process 2400 applies integration and testing. In step 2414, process 2400 performs deployment operations.

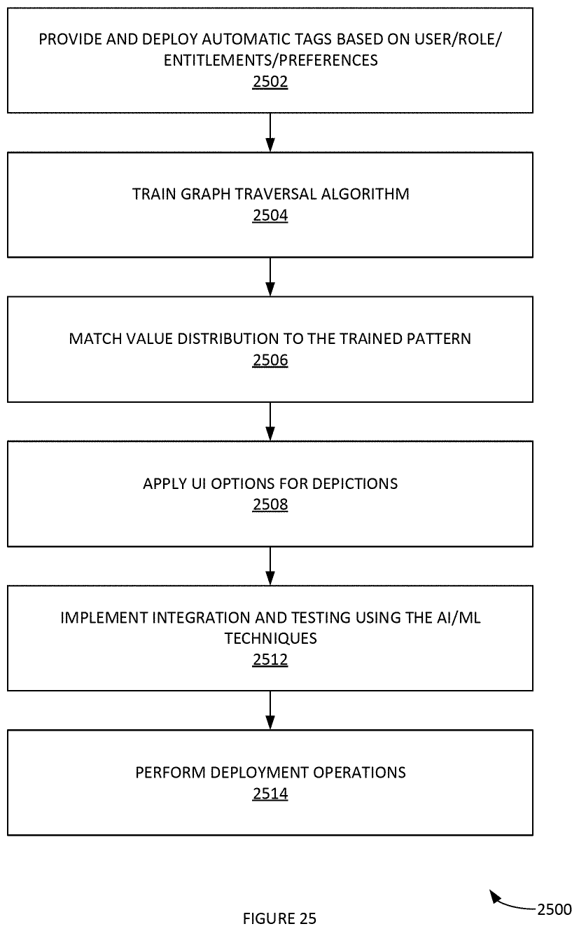

FIG. 25 illustrates an example process 2500 implemented using intelligence for adding risk scoring, according to some embodiments. Risk-based parameters to be entered into hardware risk information system 1200 may be present. However, in case some new controls are to be created, intelligence is provided by using all the data, categories, threats, and vulnerabilities that are there in the system to come up with any new control that is entered by the user. This is done a priori search algorithms that use machine learning. Also, hardware risk information system 1200 can automatically create dashboards and UI elements based on usage of the user.

In step 2502, process 2500 provides and deploys automatic tags based on user/role/entitlements/preferences. In step 2504, process 2500 trains graph traversal algorithm. In step 2506, process 2500 match value distribution to the trained pattern. In step 2508, process 2500 applies UI options for depictions. In step 2510, process 2500 applies integration and testing. In step 2512, process 2500 performs deployment operations.

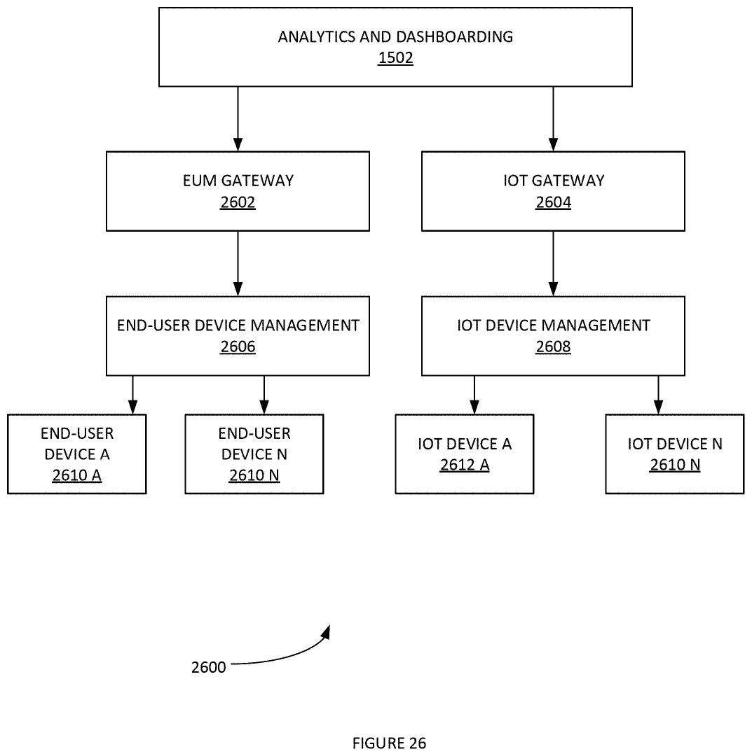

FIG. 26 illustrates an example system 2600 for aggregating risk parameters, according to some embodiments. Analytics and Dashboarding component 1502 can aggregate risk data from End User Management (EUM) gateway 2602 and IoT gateway 2604 respectively. The risk parameter related data is collected from both the end-user device management systems 2604 and IoT device management system 2606. End User Management (EUM) gateway 2602 and IoT gateway 2604 can plug into these systems and collect and summarize the data at frequent/periodic intervals. The summarized data is then presented to Analytics and Dashboarding component 1502 to be available for user insights after processing them through specified AI/ML algorithms. End-user device management systems 2604 and IoT device management system 2606 can obtain risk data from specified end-user devices 2610 A-N and/or IoT devices 2612 A-N.

System 2600 can aggregate risk parameters from devices external to the IT Datacenter (e.g. IOT/End user). All the devices outside the data center (e.g. end-user devices 2610 A-N and/or IoT devices 2612 A-N) can be controlled by management systems, i.e. end-user device management systems 2604 and IoT device management system 2606. End-user device management systems 2604 can be a service management system for end-user devices. IoT device management system 2606 can be operation management systems for managing an Internet of things systems and other devices.

AI/ML Benchmarking and Neuroscience-Based Dashboard Analytics

Neuroscience/Cognitive Sciences based User Interfaces (NCS-UI's) can be designed to identify heuristics, identify, and reduce, bias, noise, decision errors. Understanding the type of data/analytics being presented in reference to their objective: a) informing of the decision-makers mental model (e.g. situational awareness) b) informing a resourcing or posture shifting decision type of decision can also be identified along a continuum of low to high order decisions. Movement along the continuum is determinate to the level of complex reasoning required for the decision. As the decision types moves from low to higher order the level of resistance of the brain to data increases. Delivery of analytics to the decision-maker will be adjusted in ways TBD as the decision type changes.

Identification of behavior patterns when inspecting data (frequency of UI is access, length of access, interaction with graphs or charts, preference of chart types and data types (temporally static or dynamic and time sequenced, descriptive, diagnostic, or predictive analytics selected) all in relation to peers and other team members. Behavioral patterns are associated with statement categories which are related to decision-errors: E.G ‘User fills in characteristics from generalities and prior histories into their mental model’. This behavior is correlated to directly corresponding errors. E.G.: • Group Attribution Error • Ultimate Attribution Error • Stereotyping • Essentialism • Functional Fixedness • Moral Credential Effect • Just-Word hypothesis • Argument from fallacy • Authority Bias • Automation Bias • Bandwagon Effect • Placebo Effect

Upon recognition of decision-error the OptimEyes Artificial Intelligence (AI) or Artificial Neural Net (ANN) will determine the appropriate intervention. Interventions are: •

Alterations in the temporal of the delivery of information in whole or components (we can alter the time when information is delivered) • Alterations in color, size or analytic type to be more acceptable to the user. (We can switch types of visuals from chart types to information tables to suit the user's acceptance of the data format) • Framing of information can be adjusted by the AI • Speed of delivery in association with Time of deliver.

Neuroscience/Cognitive based dashboards (NCDB's) designed to reduce bias and decision errors are now described.

Integrating the body of knowledge of the Neuroscience in Decision-Making and Cognitive Psychology in conjunction with advanced algorithms and Artificial Intelligence (AI) can create interactive User Interfaces of visual analytics and Artificial Intelligence that can reduce human bias and system one (1) decision errors.

The incorporation of the body of knowledge of Neuroscience, Cognitive Psychology, and the use of ‘untrained’ Artificial Neural Networks (ANN'S) centered on understanding human behavior, preferences and individual bias can create interactive Human/Computer Interfaces which dramatically improve decision-making through the reduction of human decision errors. This is particularly true in the domain of Risky Decision-Making where organizational loss and loss to the individual is quantifiable and often extensive. Through this novel combination of scientific understanding and Artificial Intelligence neuroscience-science based dashboards can enable administrators to make near optimal and timely decisions regarding current cyber-security risks.

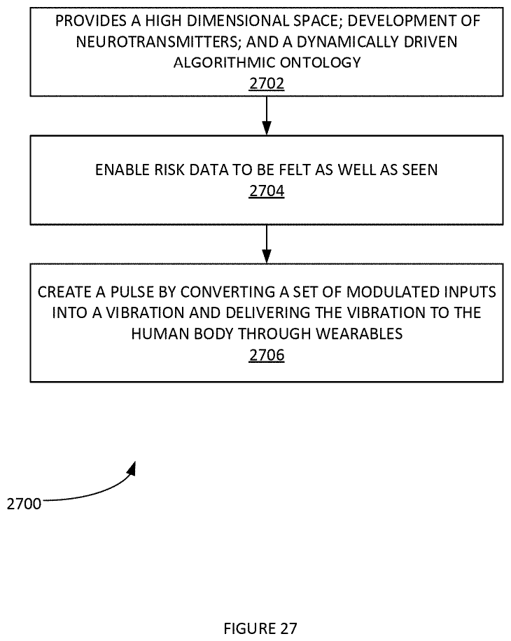

FIG. 27 illustrates an example process 2700 for sixth-sense decision-making, according to some embodiments. Sixth-sense decision-making is a decision-making technique that assists enterprises/organizations seeking to maximize the utility of available data for analysis purposes, to reduce overall risk profile. Sixth-sense decision-making includes a multidisciplinary approach used to create this new risk paradigm. In step 2702, process 2700 provides a high dimensional space; development of neurotransmitters; and a dynamically driven algorithmic ontology. In step 2704, process 2700 can enable risk data to be felt as well as seen (e.g. hence the use of the term sixth sense) to more easily identify opportunities to reduce risk. In step 2706, a pulse is created by converting a set of modulated inputs into a vibration and delivering the vibration to the human body through wearables, enabling it to be felt by humans. This pulse can include haptic signals. The attributes of the pulse can be related to various attributes of the risk (e.g. type of risk, magnitude of the risk, magnitude of remediative cost, timeline criticality, etc.).

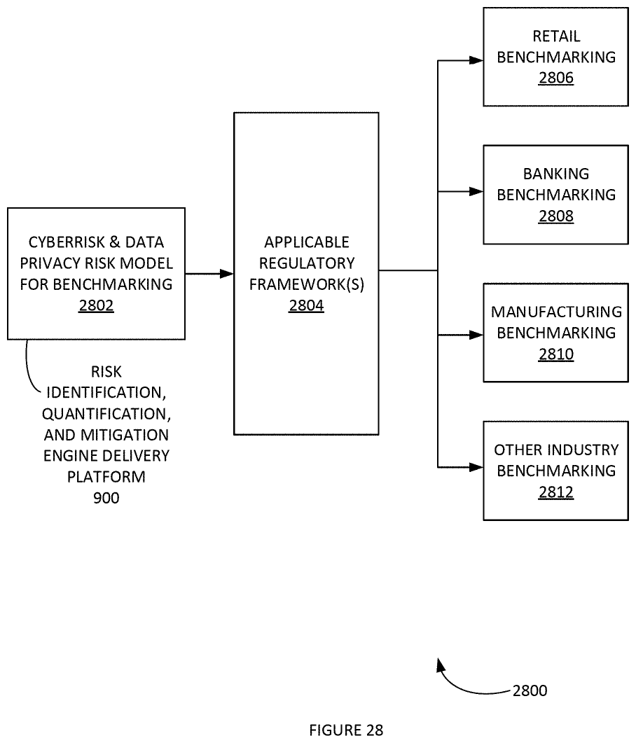

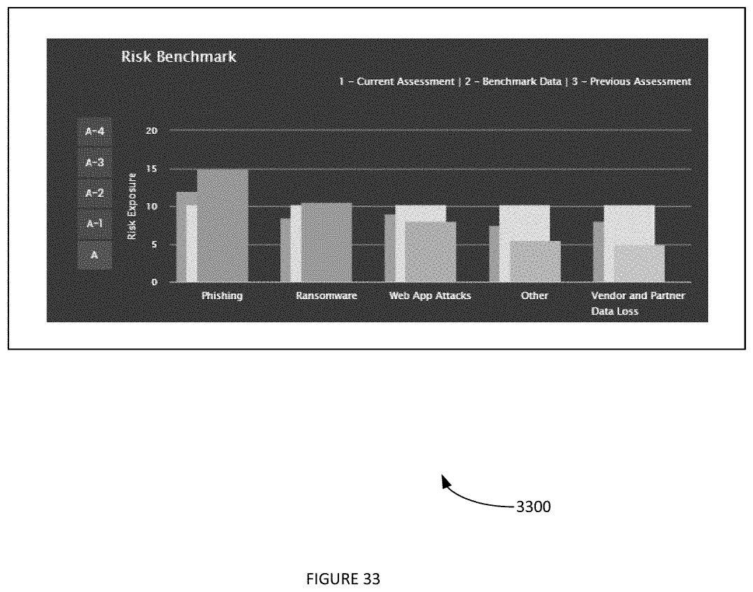

FIGS. 28-30 illustrate an example set of AI/ML benchmarking processes 2800-3000, according to some embodiments. AI/ML benchmarking processes 2800-3000 can use hub and spoke risk modeling and industry benchmarking. AI/ML benchmarking processes 2800-3000 provide entities/organizations with real-time analytics to benchmark their risk profile against their peers. AI/ML benchmarking processes 2800-3000 can provide entities/organizations with real-time analytics to benchmark their risk profile against their peers. By industry and revenue size, AI/ML benchmarking processes 2800-3000 use an algorithmic technology that aggregates benchmarking data from multiple external sources. AI/ML benchmarking processes 2800-3000 customize the analysis by cyber and data privacy risk, risk modeling systems and tools (e.g. as provided herein) and enable organizations to understand their risk profile relative to industry peers (e.g. see FIG. 33 infra). As shown, AI/ML benchmarking processes 2800-3000 can be performed by risk identification, quantification, and mitigation engine delivery platform 900.

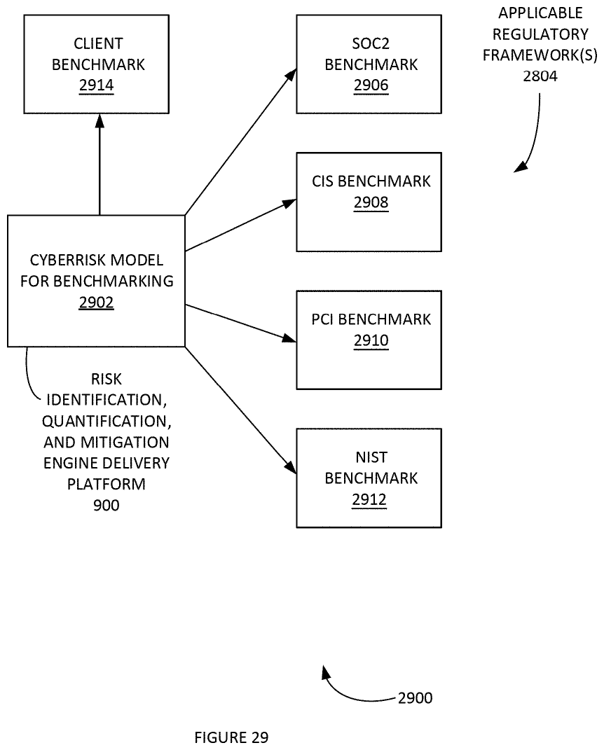

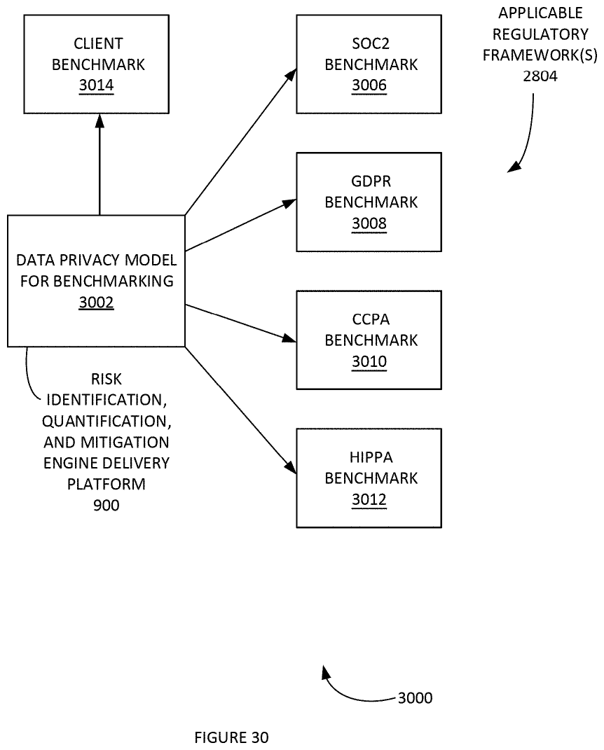

More specifically, FIG. 28 illustrates an example benchmarking process 2800 for cyber and data risk benchmarking with hub and spoke model, according to some embodiments. Benchmarking process 2800 provides a cyber risk and data privacy risk model for benchmarking 2802. Benchmarking process 2800 then obtains relevant risk data across an industry. Benchmarking process 2800 can obtain the applicable regulatory framework(s) 2804. The data for the industry is then normalized such that the benchmarking is based on each industry. Example industries include, inter alia: retail benchmarking 2806, banking benchmarking 2808, manufacturing benchmarking 2810, other industry benchmarking 2812, etc. Within each industry, benchmarks are then generated based on client size. Client size can be determined by various factors such as average annual revenue, etc. So data is then normalized based on client size as well. Benchmarks can also be separated for cyber risk and data privacy risk (e.g. as provided in FIGS. 29-30).

FIG. 29 provides a cyber-risk benchmarking process 2900, according to some embodiments. Cyber-risk benchmarking process 2900 can provide a cyber-risk model for benchmarking 2902. Cyber-risk benchmarking process 2900 can scan and ingest relevant client data. Cyber-risk benchmarking process 2900 can then quantify the risk and quantify the benchmark. Cyber-risk benchmarking process 2900 can obtain the applicable regulatory framework(s) 2804. Applicable regulatory framework(s) 2804 in the context of cyber risk can include, inter alia: SOC2 benchmark 2906, CIS benchmark 2908, PCI benchmark 2910, NIST benchmark 2912, etc. Cyber-risk benchmarking process 2900 can output client benchmark 2914.

FIG. 30 provides a data-privacy benchmarking process 3000, according to some embodiments. Data-privacy benchmarking process 3000 can provide a data privacy-risk model for benchmarking 3002. Data-privacy benchmarking process 3000 can scan and ingest relevant client data. Data-privacy benchmarking process 3000 can then quantify the data-privacy risk and quantify the data-privacy benchmark 3014. Data-privacy benchmarking process 3000 can obtain the applicable regulatory framework(s) 2804. Applicable regulatory framework(s) 2804 in the context of data-privacy risk can include, inter alia: SOC2 benchmark 3006, GDPR benchmark 3008, CCPA benchmark 3010, HIPPA benchmark 3012, etc. Data-privacy benchmarking process 3000 can output client benchmark 3014.

For each benchmarking process, the client can access two benchmarks for industry and for a similar company size. Accordingly, cyber-risk benchmark 2914 and data-privacy benchmark 3014 can include an average benchmark for each category. For example, with respect to the cyber-risk benchmark 2914, once the benchmark for overall cyber risk is obtained, process 2900 can then generate a benchmark in a specified regulatory framework. Once process 2900 creates the benchmark at the enterprise cyber level, then, with hub and spoke model, process 2900 can provide the ability for mapping and creating the benchmark from the central hub of the cyber-risk model for benchmarking 2902 (e.g. for any relevant different regulatory frameworks, etc.). This can be repeated for data privacy with its own specified regulatory frameworks. This process can also be applied to data-privacy models for benchmarking 3004 in a similar manner as well.

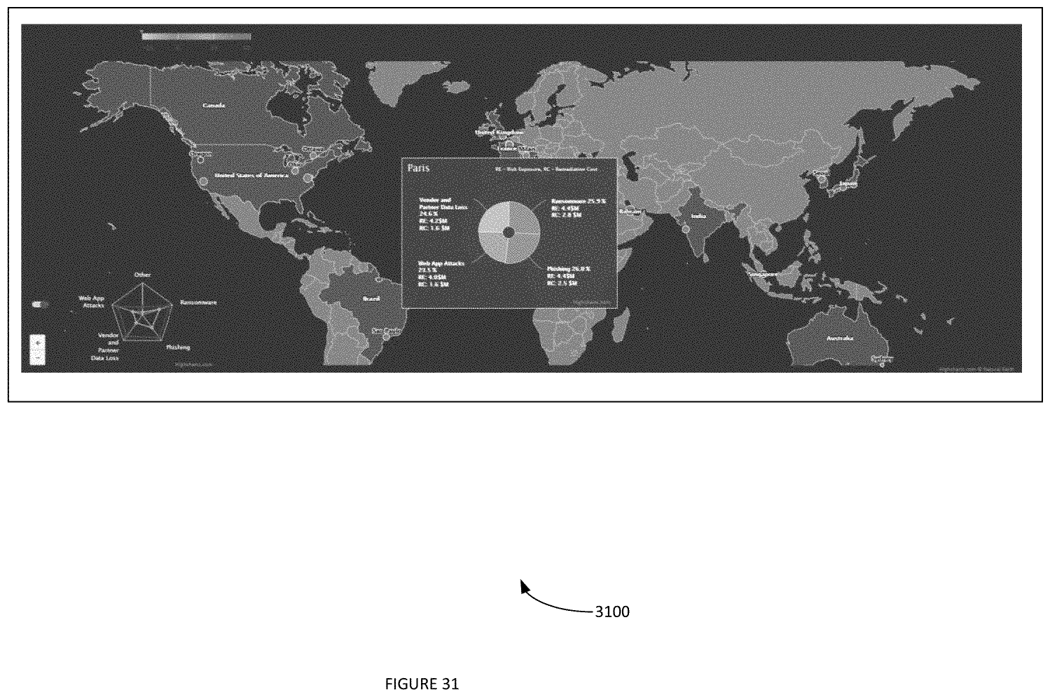

FIG. 31 illustrates an example risk geomap 3100, according to some embodiments. Risk geomap 3100 displays the underlying data in terms of risk exposure and remuneration cost at various locations across the world. The size of the bubbles show the relative value of each risk exposure. The colors show the risk state of a location. For example, a blue color shows that the Oregon-based entity has a low-risk exposure. A set of red bubbles shows locations with high-risk exposure. The bottom left-hand portion of the geomap 3100 provides a spider chart. The spider chart symbolically provides an overall risk exposure. The overall risk exposure can show an aggregated risk that includes all the regions shown in the risk geomap 3100. Additionally, the spider chart can show multivariate risk data represented on its various axes. Each axis can quantify a specified threat.

Risk geomap 3100 can be used as a homepage for a risk management services administrator. Risk geomap 3100 can be updated in real time (e.g. assuming process, networking and/or other latencies). The dashboard can provide an aggregated and global view of the top risks to an enterprise/organization.

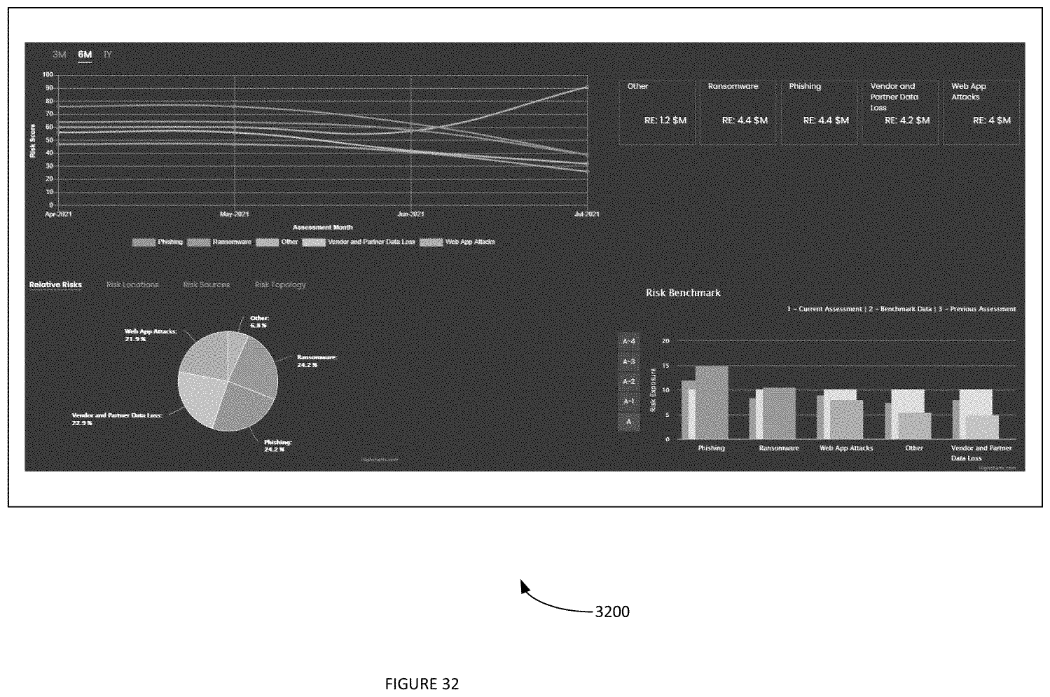

FIG. 32 illustrates an example risk analytics dashboard 3200, according to some embodiments. Risk analytics dashboard 3200 shows a set of risks/threats across a specified time period. Accordingly, risk analytics dashboard 3200 can include historical information about risks and their respective temporal trends. Risk types can be color coded as well. A user can toggle between various time periods as well (e.g. a three-month period, a six-month period, a year, etc.). The top right-side portion of risk analytics dashboard 3200 shows the risk exposure for specified categories of risk in monetary terms. The specified categories can include, inter alia: ransomware, phishing, vendor partner data loss, web application attacks, other risks, etc.

Risk analytics dashboard 3200 includes a risk benchmark chart in the lower right-hand side. FIG. 33 illustrates an example risk benchmark chart 3300 according to some embodiments. Risk benchmark chart 3300 includes three levels for each category of risk. A first level can be a level of each risk for a current month (or other time period being analyzed). The middle level is an AI/ML generated benchmark level for the month (or other time period being analyzed). A third level can be a risk level for a previous month (or other time period being analyzed). It is noted that the AI/ML generated benchmark level is generated from an AI/ML model as generated and updated per the discussion supra. The benchmark levels can be generated and updated by AI/ML benchmarking processes 2800-3000.

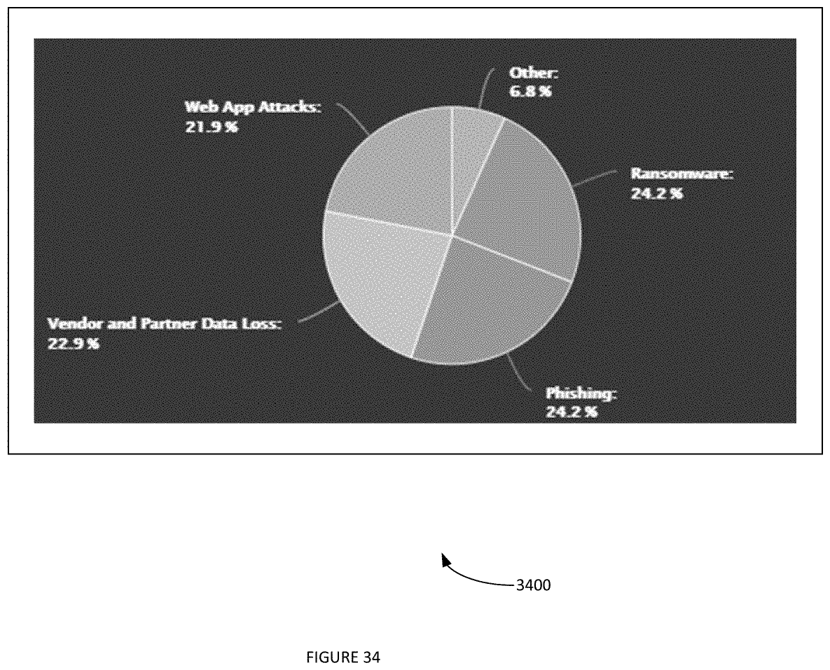

Risk analytics dashboard 3200 includes a set of risk exposure distribution by threats, locations, sources, and topology charts in the low left corner. FIGS. 34-36 illustrate an example set of charts showing risk exposure distribution by threats, locations, sources, and topology 3400-3600, according to some embodiments. More specifically, FIG. 34 illustrates an example pie chart 3400 providing the percentages of current relative risks, according to some embodiments.

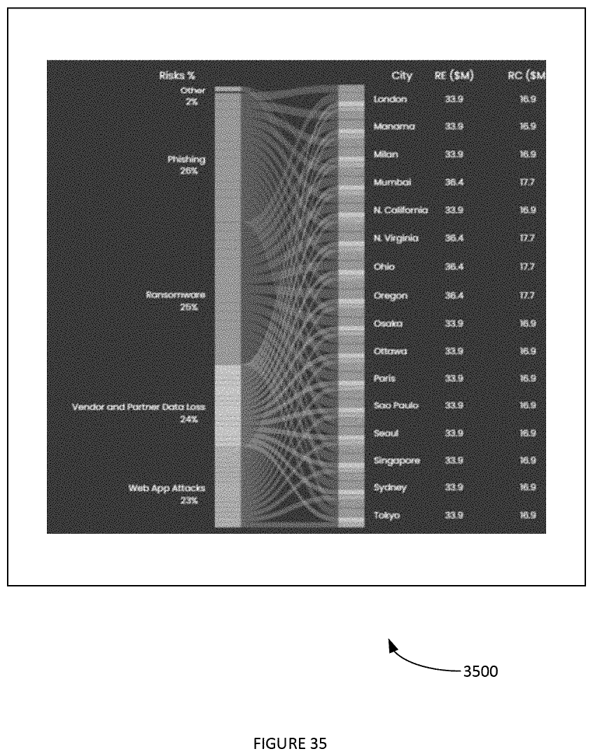

FIG. 35 illustrates an example chart 3500 providing the percentages of current relative risks for a set of geographic locations, according to some embodiments. In the present example, these are based on city locations. In other examples, other geographic locations can be utilized as well (e.g. store locations, campuses, states, nations, etc.). Chart 3500 also breaks up the relative risk exposure costs and other costs (e.g. remediation costs, etc.) on a location-by-location basis as well. The thickness of a line can represent a quantification of a risk.

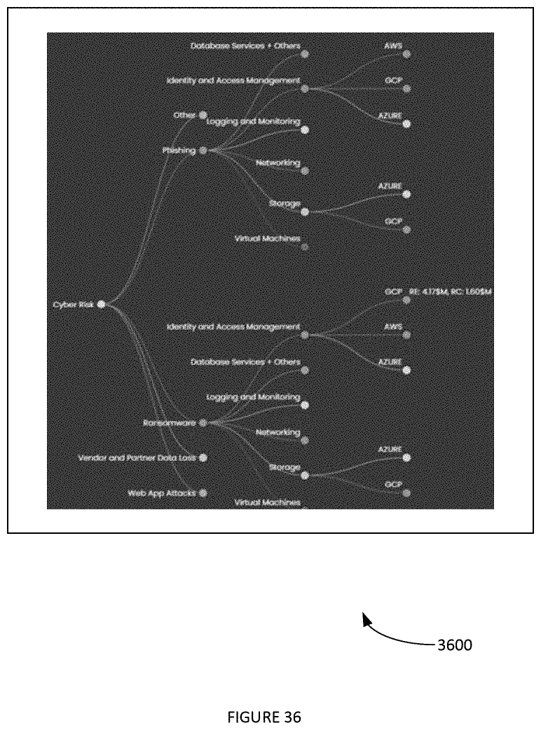

FIG. 36 illustrates an example tree map 3600 showing a risk topology, according to some embodiments. This risk topology is broken up into three layers in a hierarchal node structure. Each node can be accessed to show a lower layer. A first layer can be a threat type. These can be the specified risk categories discussed supra (e.g. ransomware, phishing, vendor partner data loss, web application attacks, other risks, etc.). A second layer can be a threat category. A third layer can be threat-related assets. Threat categories within each risk category of the first layer can include, inter alia: database services, identity and access management, logging and monitoring, networking, storage, etc. Each node of the second layer can be accessed to view the relevant nodes of the third layer. For example, the second layer's identity and access management node of the phishing node can be accessed to view threats related to AWS®, GCP® and/or Microsoft Azure® systems for that node. Each asset can also be accessed to view estimated risk exposure costs and other costs for the specific asset.

In one example, a computerized process that provides risk model solutions to organizations across multiple industries, including financial services, healthcare, and retail, with a particular focus on cyber, data privacy and compliance risk. The computerized process can use computer hardware and software, AI, and machine learning to implement solutions that enable real time and continuous quantification of risk, calculation of annual loss expectancy and risk remediation costs, industry risk benchmarking and neuroscience-based dashboard analytics. A flexible use case architecture can be used to support client-specific risk program requirements and priorities.

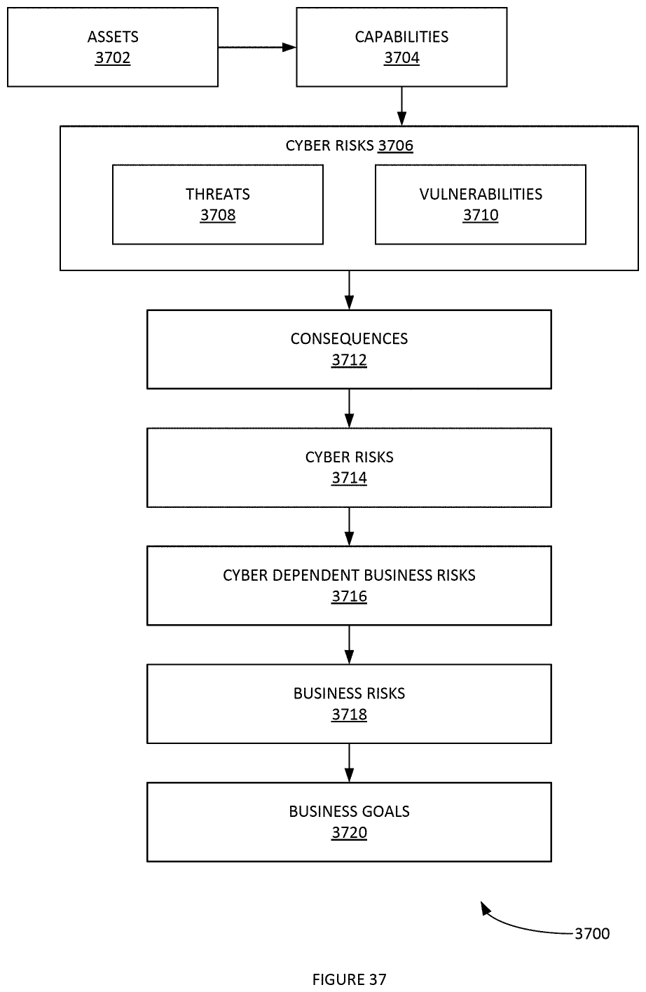

FIG. 37 illustrates an example system 3700 for AI/ML modeling, according to some embodiments. It is noted that the risk charting for an organization depends primarily depends on the business goals 3720 (e.g. new customers, mergers, and acquisitions, etc.) of the organization. In some examples, business goals 3720 can be enterprise and/or organization goals. The list the business goals 3720 that the organization may seek to achieve and the mapping of these business goals can be achieved based on a set of business risks being below a particular threshold is available in the business risks 3718. The set of business risks (e.g. business continuity, supply chain, etc.) may contribute based on a predefined set of weights to the business goals listed above. These relationships are automatically learnt using an AI/ML algorithm and based on the scoring of risks the probability of achieving the business goals 3720 is automatically calculated. The set of business risks 3718 and its relationship to the cyber dependent business risk 3716 is provided in cyber dependent business risk 3716. Each of the business risks 3718 can be contributed to by a cyber-dependent business risk 3716 (e.g. brand, customer trust, etc.).

The cyber dependent business risk 3716 is a set of cybersecurity parameters that are mapped to business risk 3718. The mapping is provided in cyber risks 3714 (e.g. compliance failure, cyber risks, IP loss, etc.) are now mapped onto consequences of a breach and is available in threats 3708. Threats 3708 are based on how much the threat actor is, inter alia: motivated, capable, and willing to breach the organization. The subcategories for capable, motivated, and willing and the list of threat actors, along with the mapping to the consequences, is available in the values matrix and can vary by industry consequences.

Consequences 3712 (e.g. ransom, service degradation, IP theft, etc.) may be one set of final values that an organization might want to mitigate. It is noted that the dollar value consequence exposure can be provided.

Capabilities 3704 (e.g. segmentation, visibility, real-time analytics, etc.) are values that strengthen the risk posture of an organization and valuate the internal strength. These capabilities are provided by systems that are bought or created for the risk mitigation. There can be a total of thirty-one (31) capabilities that may be provided by a smaller number of systems. The mapping of capabilities and the four vulnerability dimensions 3710 include, inter alia: architecture, hygiene, operations, and process products (e.g. Rapid7, Qualys, ServiceNow, etc.) provide some of the capabilities 3704 that are needed for risk mitigation. The mapping of all the products with the higher-level capabilities is provided in the controls at the lowest level are the controls (e.g. Java se embedded vulnerability 3710 (e.g. cve-2020-2590)) are connected to the assets (e.g. web application server).

Cyber risks 3706 can be based on assets 3702 and vulnerabilities 3710. Assets 3702 can be connected to either a software, hardware, services, people, or accessibility. The assessment for these controls are mostly collected automatically and wherever there is a gap we try to use a questionnaire to collect the inputs.

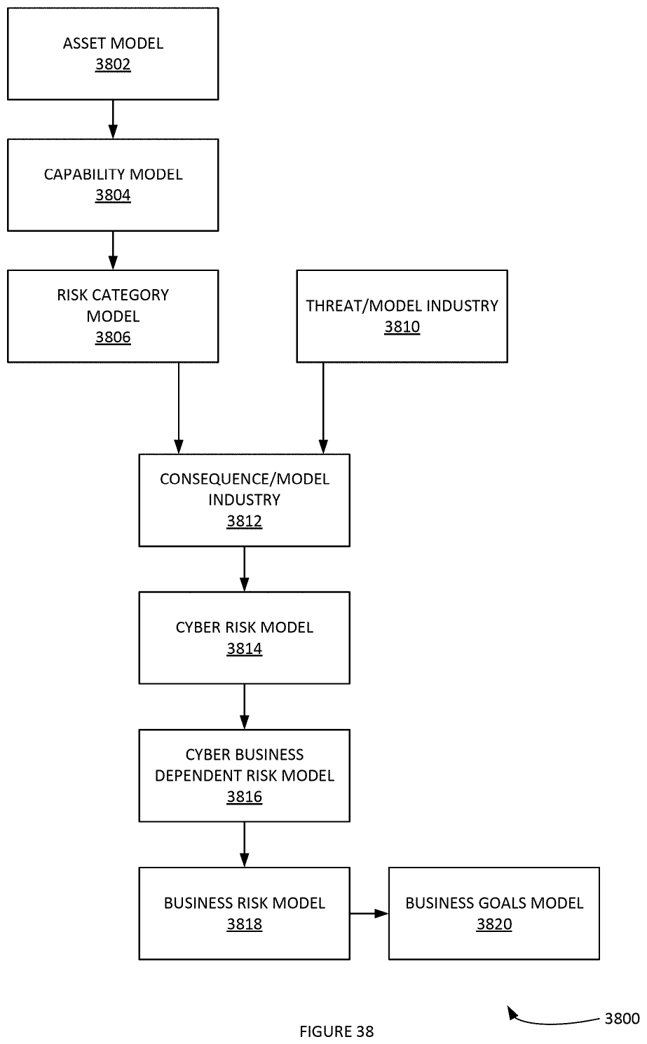

FIG. 38 illustrates an example hierarchy of models 3800, according to some embodiments. Hierarchy of models 3800 includes, inter alia: asset model 3802, capability model 3804, risk category model 3806, threat/model industry 3810, consequence/model industry 3812, cyber risk model 3814, cyber business dependent risk model 3816, business risk model 3818, and business goals model 3820.

Asset model 3802 can input controls for a specified cloud platform (e.g. AWS, Azure, GCP, VMWare, etc.) and output risk/RE/RC Model at the cloud platform level (e.g. AWS, Azure, GCP, VMWare level) to Capability model 3804. Capability model 3804 can output risk/RE/RC Model at the capability level (e.g. access, control, IAM, etc.) to risk category model 3806. Risk category model 3806 can output cyber risk/RE/RC at the category level (e.g. hygiene, operations, architecture, process, etc.) to consequence/model industry 3812.

Threat/industry model 3810 can obtain capable, motivated, willing scores and output threat actor level scores to consequence/industry model 3812.

Consequence/industry model 3812 can output ransom, service degradation, IP theft, etc. to cyber risk model 3814. Cyber risk model 3814 outputs compliance failure, insider breech, IP loss, etc. to cyber business dependent risk model 3816. Cyber business dependent risk model 3816 can output brand, customer trust, continuality, etc. to business risk model 3818. Business risk model 3818 can output business continuity, climate, competition, etc. to business goals model 3820. Business goals model 3820 probability of achieving goals (e.g. geographic, diversity, revenue growth, margin, etc.).

The entire hierarchy of models 3800 starts from the initial asset models 3802, that feed into capability models 3804. Capability models 3804 feed into risk category models 3806. Risk category model 3806, along with the threat/model industry 3810 feeds into the consequence/model industry 3812. The consequence/model industry 3812 feeds the cyber risk model 3814 that in turn feeds into the cyber dependent risk model 3816. Cyber dependent risk model 3816 feeds into the business risk model, that finally feeds into the business goals model 3820. Each of these models can have default training using synthetic data. Once process 3800 acquires data from reports then it can retrain the models 3802-3812 according to industry reports. Process 3800 obtains specified customer data in a particular industry, then it can retrain the data-specific models for that industry.

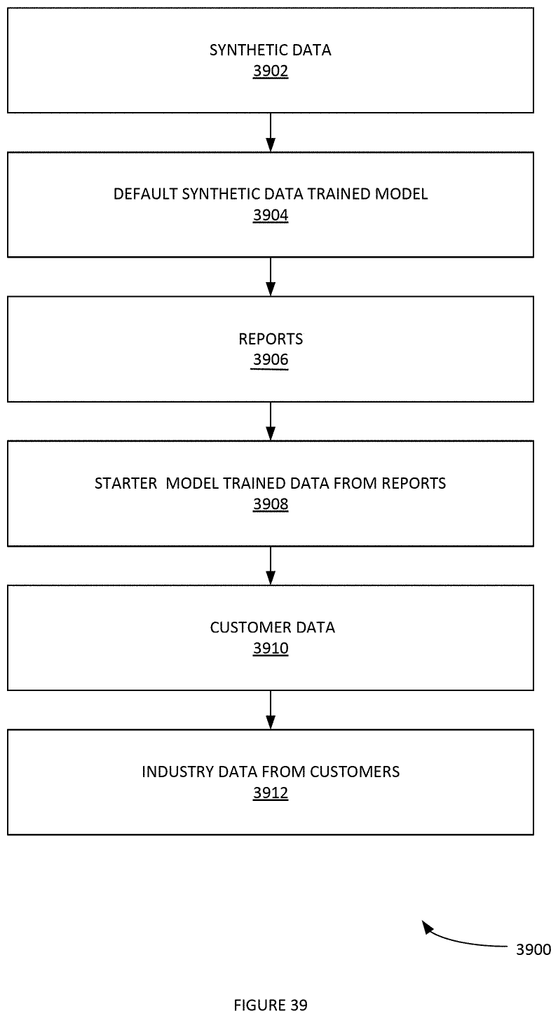

FIG. 39 illustrates an example process flow utilizing synthetic data, according to some embodiments. Synthetic data 3902 is used to create a default synthetic data trained model 3904. This default synthetic data trained model 3904 can then be used with reports 3906 to generate a starter model trained data from reports 3908. Starter model trained data from reports 3908 can then be used with customer data 3910 to generate industry data from customers 3912.

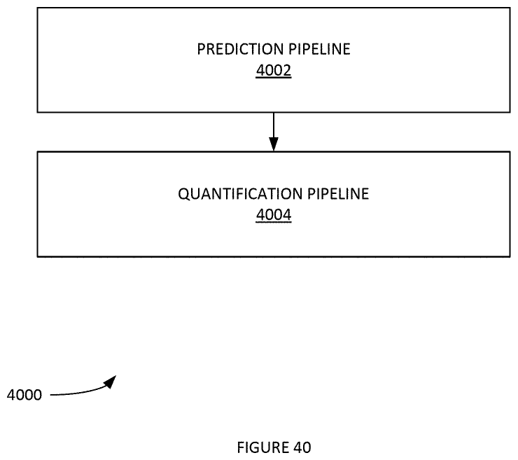

FIG. 40 illustrates an example AI/ML pipeline 4000, according to some embodiments. There are two type of pipelines (e.g. prediction pipeline 4002 and quantification pipeline 4004) utilized by AI/ML pipeline 4000. AI/ML pipeline 4000 easily malleable according to new datatypes.

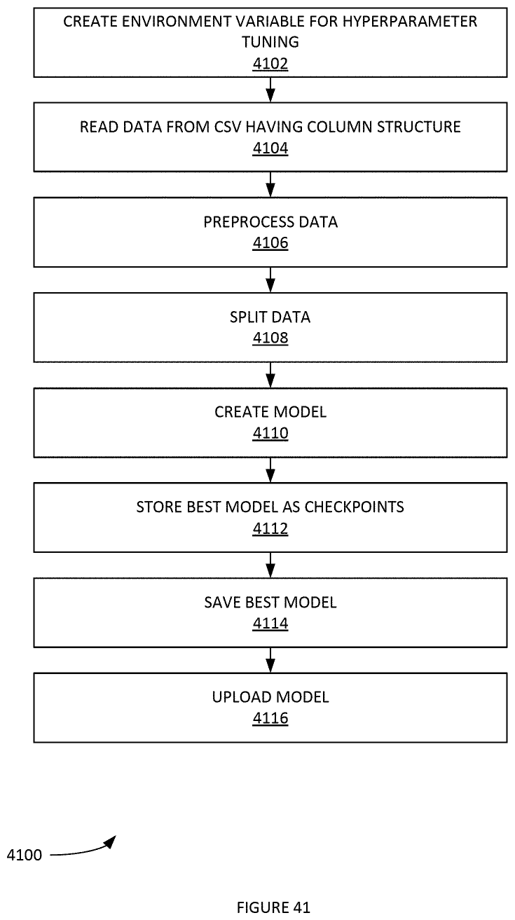

FIG. 41 illustrates an example prediction pipeline 4100, according to some embodiments. In step 4102, for each model as pipeline, process 4100 can create environment variable for hyperparameter tuning (e.g. EPOCH, batch_size, learning rate etc.). In step 4104, process 4100 can read data from a CSV file having column structure: <date>,<slider_max>,<rs-chap_1>,<rs-chap_2>,<rs-chap_3> . . . <re-chap_1>,<re-chap_2>,<re-chap_3> . . . <rc-chap_1>,<rc-chap_2>,<rc-chap_3> . . . .

In step 4106, process 4100 can preprocess data. This can include, inter alia: decompose date, drop null rows, etc. In step 4108, process 4100 can split data. For example, process 4100 can make windowed data from series object and store it as NumPy.

In step 4110, process 4100 can create a model. Process 4100 can use a create model architecture (e.g. Wavenet, etc.). In step 4112, process 4100 can store the best model as check points. In step 4114, process 4100 can save the best model (e.g. as *.h5i). In step 4116, process 4100 can upload the Artifact.

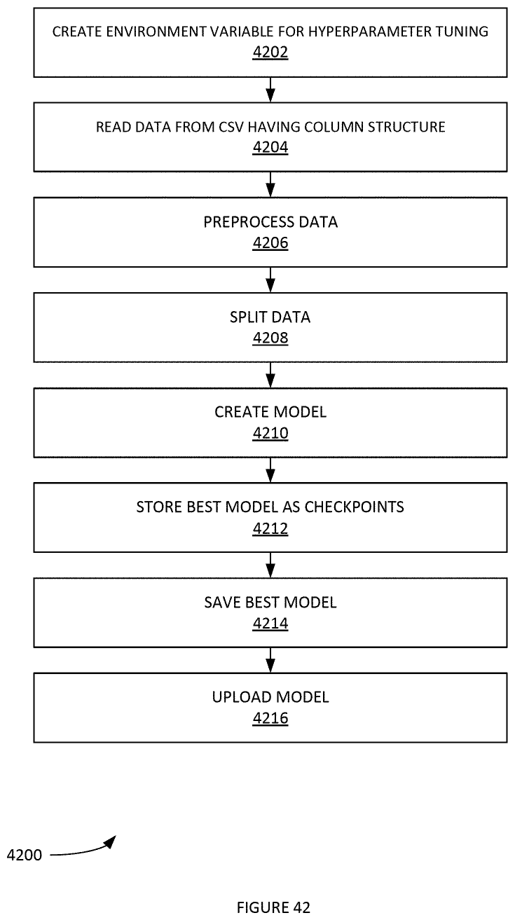

FIG. 42 illustrates an example quantification pipeline 4200, according to some embodiments. For each model as a pipeline process 4200 can perform the following steps. In step 4202, process 4200 can create environment variable for hyperparameter tuning (e.g. EPOCH, batch_size, learning rate etc.).

In step 4204, process 4200 can read data from a CSV file having column structure:<control_1>,<control_2>,<control_3> . . . <chapter_score> . . . . In step 4206, process 4200 can preprocess data (e.g. decompose date, drop null rows, etc.). In step 4208, process 4200 can split data. For example, process 4200 can make windowed data from series object and store it as numpy. In step 4210, process 4200 can create the model. Process 4200 can use a create model architecture (e.g. Xgboost, etc.). In step 4212, process 4200 can store the best model as checkpoints. In step 4214, process 4200 can save the best model (e.g. as *.h5i). In step 4216, process 4200 can upload the artifact.

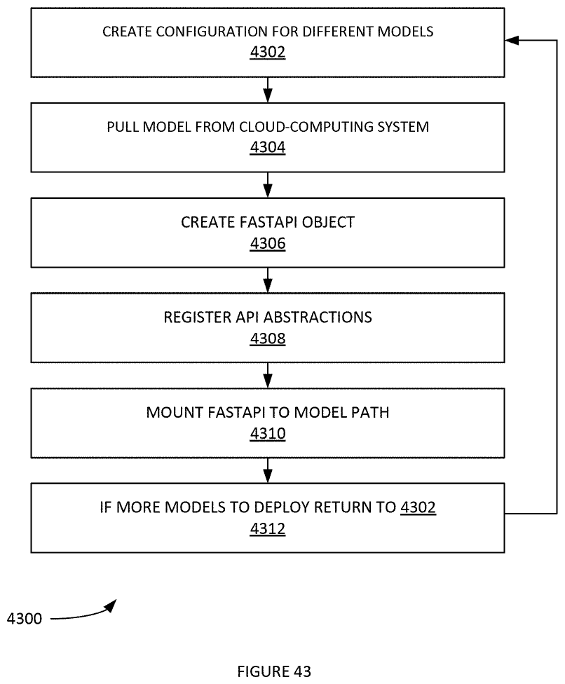

FIG. 43 illustrates a FastAPI object creation and mounting process 4300, according to some embodiments. Process 4300 provides how models can be hosted using FastAPI. It is noted that a RESTful interface can also be utilized by process 4300. The figure above shows the hosting methodology. In step 4302, process 4300 creates a configuration for different models. In step 4304, process 4300 pulls model from cloud-computing system. In step 4306, process 4300 creates FastAPI object. In step 4308, process 4300 registers the API abstractions. In step 4310, process 4300 mounts the FastAPI to model path. In step 4312, if there are more models to deploy, process 4300 returns to step 4302.

It is noted that FastAPI can be Web framework for developing RESTful APIs in Python. FastAPI can be used for type hints to validate, serialize, and deserialize data, and automatically auto-generate OpenAPI documents. It is noted that FastAPI is provided by way of example and in other embodiments other versions of this type of functionality can be used.

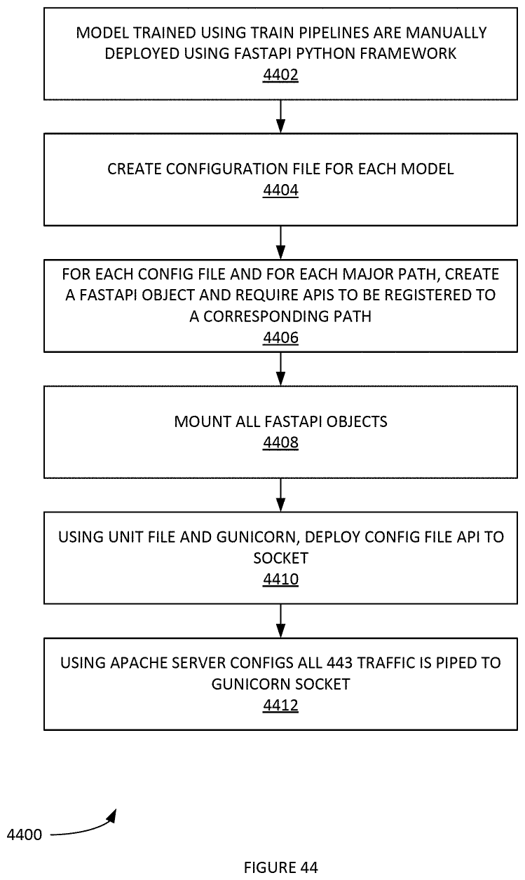

FIG. 44 illustrates an example process 4400 for deploying an API configuration file to a socket, according to some embodiments. In step 4402, process 400 can provide a model trained using train pipelines that are manually deployed using FastAPI Python (and/or similar) framework. In step 4404, process 4400 can create configuration file for each model. In step 4406, for each config file and for each major path, process 4400 creates a FastAPI object and require APIs to be registered to a corresponding path. In step 4408, process 4400 mounts all FastAPI objects 4408 using unit file and Gunicorn (and/or another WSGI). In step 4410, process 4400 deploys the configuration file API to the socket. In step 4412, process 4400 uses a server system (e.g. an Apache® server, etc.) configurations such that all 443 traffic (i.e. TCP port 443, the default port for HTTPS network traffic) is piped to the Gunicorn socket. It is noted that because all APIs are internally used, process 4400 does not use an API gateway for servicing requests.

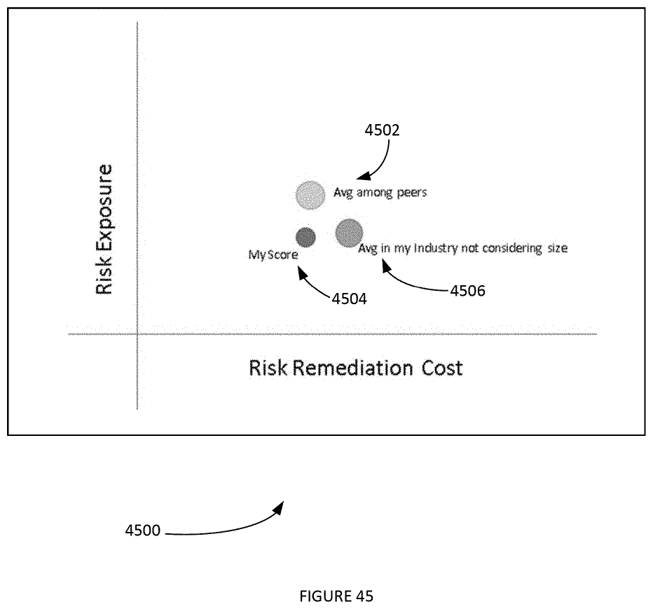

FIG. 45 illustrates an example screen shot 4500 of a chart illustrating example risk values, according to some embodiments. Benchmarking is a reference list of Risk Values for a company to compare against and for weighing their overall enterprise risk, risk exposure and risk remediation cost. These three values can be represented in a chart form as shown in FIG. 45. As shown, blob 4504 represents three dimensions including Risk Exposure, Risk Remediation cost and the size of blob is equivalent to the Risk Score for this users company. Blob 4506 represents the same three values for the entire industry. Blob 4502 represents the same three value for the peers of the users company considering the size (e.g. revenue, number of employees etc.).

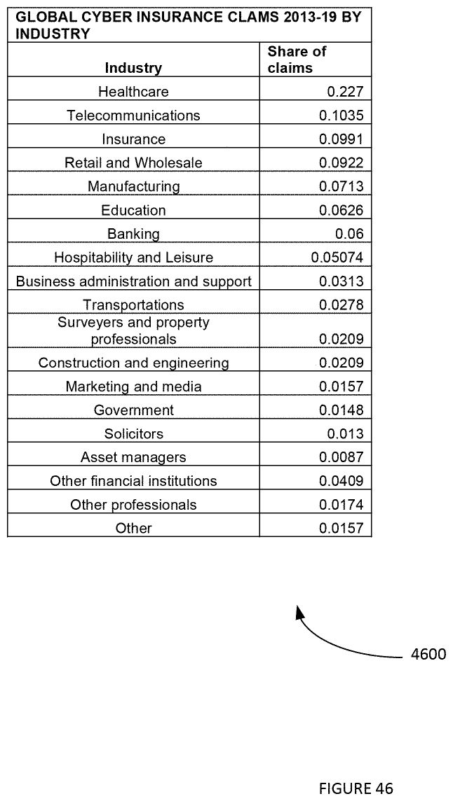

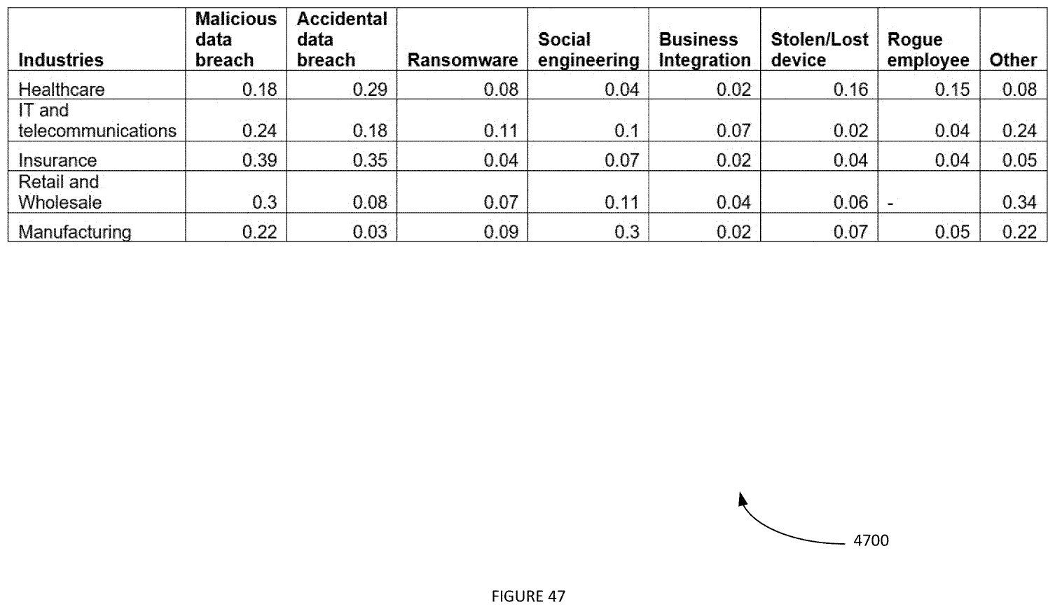

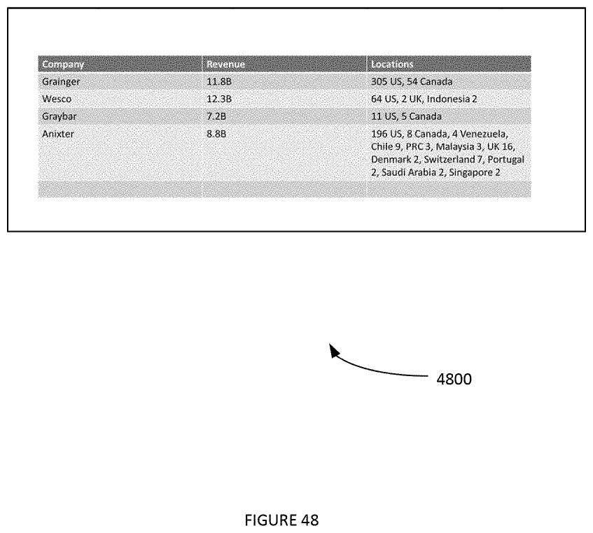

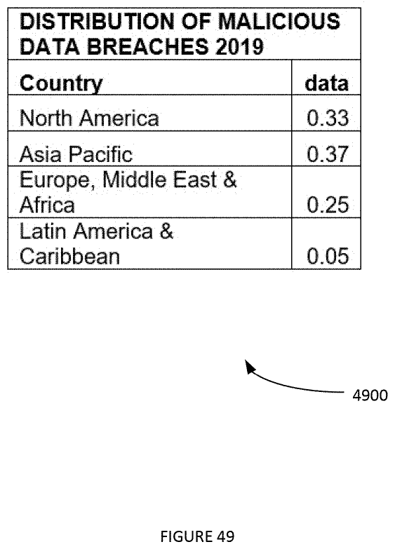

FIGS. 46-49 illustrates an example tables 4600-4900 of synthetic data that can be utilized by the systems and processes provided herein, according to some embodiments. Tables 4600-4900 and their respective values are provided by way of example and not of limitation. It is noted that due to unavailability of all data elements we use synthetic data for all gaps. The following criteria can be considered when for generating the comparison scores by industry (e.g. the risk appetite varies depending on the industry).

Table 4600 shows example cyber insurance claims according to industries. The normalized values in the share of claims column can be used for weighing the industry when it comes to cybersecurity risk. For industries not in the list the “Other” value can be used.

Table 4700 shows threat deviation amongst industries values. It is noted that for industries not in the list a mean value can be used.

It is noted that, risk appetite of a company may be higher or lower based on its revenue. These states can be quantified and represented. In table 4800, an average of the entire industry can be used for the industry level comparison and an average of closest peers can be considered for the peer level comparison.

Table 4800 shows example synthetic locations data. Table 4800 shows locations where the data is placed can be rated and considered for the three scores. As represented in table 4800, locations can be widely different even amongst peers. This data can be used in a peer comparison. For an industry comparison, a template company can be utilized. This template company can be worldwide in all continents.

Table 4900 shows synthetic data that can represent the quantified risk for continents. It is noted that a mean score can be used for continents not represented.

Synthetic data can be generated that quantifies a risk appetite. This synthetic data can be generated for peer and industry. A real score can be used for the users company.

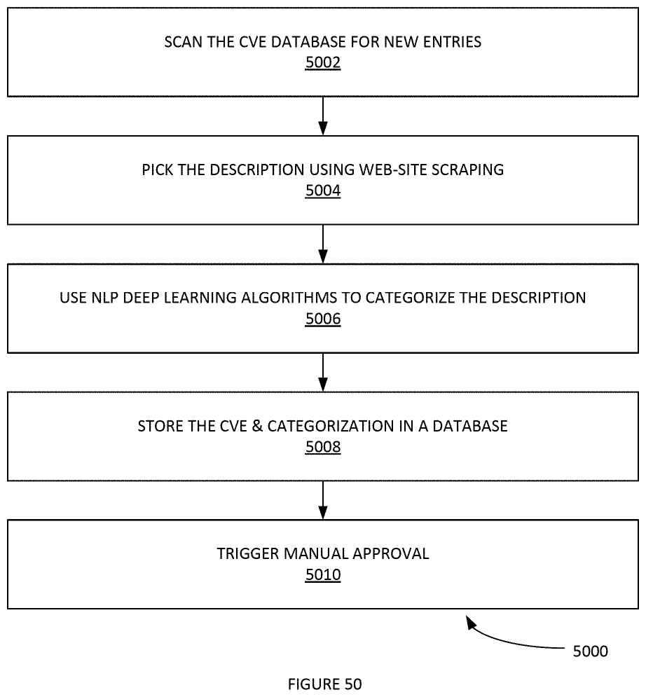

FIG. 50 illustrates an example process 5000 for triggering manual approval, according to some embodiments. In step 5002, process 5000 can scan the CVE database for new entries. In step 5004, process 5000 can pick the description using web-site scraping. In step 5006, process 5000 can use NLP deep learning algorithms to categorize the description. In step 5008, process 5000 can store the CVE and categorization in a database. In step 5010, process 5000 can trigger manual approval.

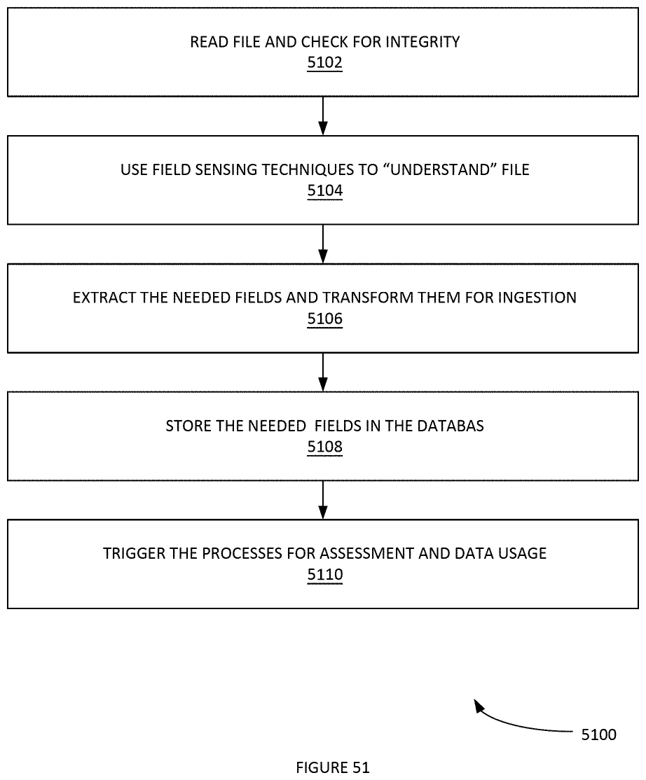

FIG. 51 illustrates an example process 5100 for triggering assessment and data usage, according to some embodiments. In step 5102, process 5000 can read file and check for integrity. In step 5104, process 5000 can use field sensing techniques to “understand” file. In step 5106, process 5100 can extract the needed fields and transform them for ingestion. In step 5108, process 5100 can store the needed fields in the database. In step 5110, process 5100 can trigger the processes for assessment and data usage.

Additional Computing Systems

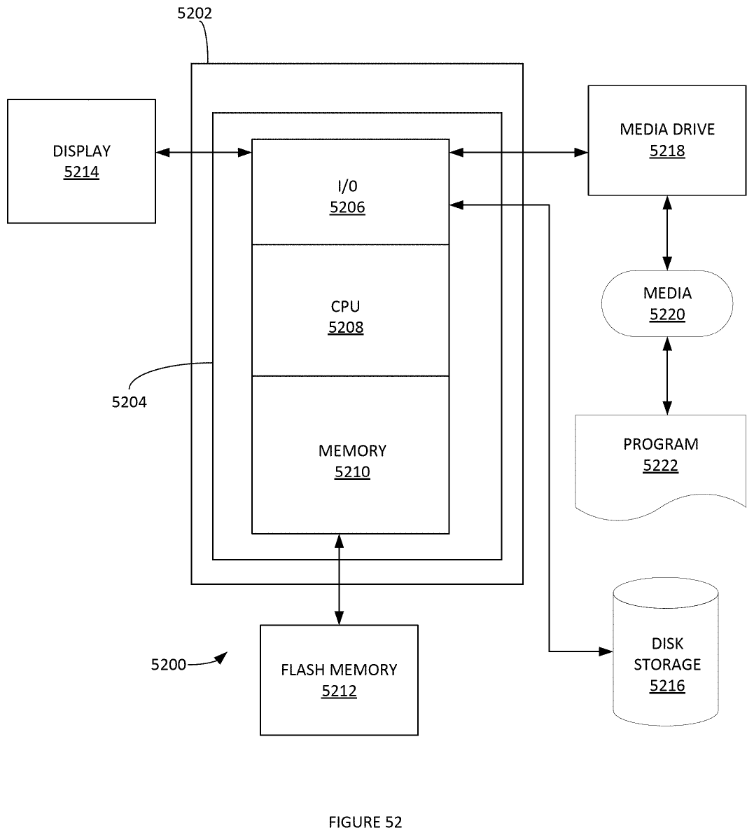

FIG. 52 depicts an exemplary computing system 5200 that can be configured to perform any one of the processes provided herein. In this context, computing system 5200 may include, for example, a processor, memory, storage, and I/O devices (e.g., monitor, keyboard, disk drive, Internet connection, etc.). However, computing system 5200 may include circuitry or other specialized hardware for carrying out some or all aspects of the processes. In some operational settings, computing system 5200 may be configured as a system that includes one or more units, each of which is configured to carry out some aspects of the processes either in software, hardware, or some combination thereof.

FIG. 52 depicts computing system 5200 with a number of components that may be used to perform any of the processes described herein. The main system 5202 includes a motherboard 5204 having an I/O section 5206, one or more central processing units (CPU) 5208, and a memory section 5210, which may have a flash memory card 5212 related to it. The I/O section 5206 can be connected to a display 5214, a keyboard and/or another user input (not shown), a disk storage unit 5216, and a media drive unit 5218. The media drive unit 5218 can read/write a computer-readable medium 5220, which can contain programs 5222 and/or databases. Computing system 5200 can include a web browser. Moreover, it is noted that computing system 5200 can be configured to include additional systems in order to fulfill various functionalities. Computing system 5200 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed by United States patent is:

1. A hardware risk information system for implementing a local risk information agent system for assessing a risk score from a hardware risk information comprising:
a local risk information agent that is installed in and running on a hardware system of an enterprise asset, wherein the local risk information agent manages a collection of the hardware risk information used to calculate a risk score of the hardware system of the enterprise asset by tracking a specified set of parameters about the hardware system, wherein the local risk information agent pushes the collection of the hardware risk information to a risk management hardware device, and wherein on a periodic basis, the local risk information agent uses a risk management hardware device to write the collection of the hardware risk information in a secure manner using a cryptographic key;
a risk management hardware device comprising a repository for all the risk parameters of the hardware system of the enterprise asset, wherein the risk management hardware device generates the risk score for the hardware system using the collection of the hardware risk information, and wherein the risk management hardware device comprises a neural network processing unit (NNPU) used for local machine-learning processing and summarization operations used to generate the risk score, wherein the risk management hardware device authenticates the collection of the hardware risk information using the cryptographic hardware and then writes the collection of the hardware risk information onto an internal memory, and wherein the NNPU is configured to receive the collection of the hardware risk information for creating a risk score based on a current chunk of data and the older risk scores, and uses one or more machine learning (ML) models to calculate the risk score at an enterprise asset's system level of the enterprise asset; and
an analytics and dashboarding component that receives the risk score and provides the risk score as the risk score information via a set of graphical components viewable by a user, and wherein the set of graphical components displays a set of insights about the plurality of enterprise assets based on the risk score data obtained by the plurality of local risk information agents.

2. The hardware risk information system of claim 1, wherein the NNPU uses a hierarchy of models to calculate the risk score.

3. The hardware risk information system of claim 2, wherein the hierarchy of models comprises an asset model, a capability model, a risk category model, and a threat/industry model.

4. The hardware risk information system of claim 3, wherein the hierarchy of models comprises a consequence-industry model, a cyber risk model, a cyber business dependent risk model, a business risk model, and a business goals model.

5. The hardware risk information system of claim 4, wherein the asset model inputs a set of cloud platform parameters and outputs the risk model at the cloud-platform level to the capability model.

6. The hardware risk information system of claim 5, wherein the capability model outputs the risk model at the capability level to the risk category model.

7. The hardware risk information system of claim 6, wherein the risk category model outputs the risk model at the category level to the threat/industry model.

8. The hardware risk information system of claim 7, wherein the threat/industry model obtains a capable, motivated, willing scores and outputs an output threat actor level score to the consequence-industry model.

9. The hardware risk information system of claim 8, wherein the consequence-industry model outputs a ransom probability score, a service degradation probability score and a intellectual property probability score to the business risk model and the business risk model is used to generate the business goals model.

10. The hardware risk information system of claim 4, wherein the business risk model outputs a business continuity score, a climate score, and a competition score to the business goals model.
